(19) United States
(12) Patent Application Publication
(10) Pub. No.: US 2005/0149853 A1
(43) Pub. Date: Jul. 7, 2005

(54) Document display program and method

(75) Inventor: Masaya Naitou, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED

(21) Appl. No.: 10/968,907

(22) Filed: Oct. 21, 2004

Related U.S. Application Data
(63) Continuation of application No. PCT/JP02/04101, filed on Apr. 24, 2002.

(51) Int. Cl. G06F 17/00

(52) U.S. Cl. 715/501.1; 715/513

(57) ABSTRACT

Document display program and method which permit link information in a document to be visually distinguished with ease. When a document is input, link information including location information of a linked document and description content indicative of the presence of a link is extracted from the input document (Step S1). Then, an object corresponding to the extracted link information is generated (Step S2), and the document is displayed together with the generated object in such a display form as to include the description content included in the corresponding link information (Step S3). On selection of the object by an input operation, the linked document is acquired in accordance with the location information included in the link information corresponding to the selected object (Step S4).

This application is a continuing application, filed under 35 U.S.C. § 111(a), of International Application PCT/JP02/04101, filed Apr. 24, 2002.

### BACKGROUND OF THE INVENTION

1. Field of the Invention

The present invention relates to a program, method and device for displaying a document and a computer-readable recording medium recording the document display program. More particularly, the invention relates to a program, method and device for displaying a document containing a link anchored to a different document and a computer-readable recording medium recording the document display program.

2. Description of the Related Art

In recent years, web content on the Internet or intranets is more and more increasing. Moreover, ever-spreading broadband communication is expected to bring about an explosive increase of web content.

To view web content, a browser installed on a computer is used. A user enters the location of content (e.g., URL (Uniform Resource Locator)) on the browser, whereupon the browser acquires, via the Internet or intranet, a target document described in HTML (Hyper Text Markup Language) or XML (extensible Markup Language). The browser then decodes the acquired document and displays the result.

In many cases, the document thus displayed contains link information anchored to different documents. For example, in an HTML document, anchor tags are used to designate a linked document. In an XML document, XLink description is used to designate a linked document.

Where a document displayed by the browser contains link information, the mouse pointer may be moved on the display screen to a position (link information) where a link has been set and the mouse button may be clicked, whereupon the link information is selected. On selection of the link information, a linked document set in the link information is acquired by the browser and displayed. By following links in this manner, it is possible to browse desired content only by a simple manipulation of the mouse.

In most cases, link information is displayed in a manner distinguishable from other parts on the screen by using underline or different colors.

Depending on the background color or the screen layout, however, it is sometimes difficult to distinguish link information. Also, in some documents, portions of text which are to be merely emphasized (not link information) are underlined or shown in different colors. In such cases, it is difficult to distinguish between the merely emphasized portions of text and link information. Moreover, if the user is not accustomed to manipulation of the browser, he/she will find it even more difficult to distinguish link information and will not know what to do on the current display screen to switch to a target screen.

Meanwhile, in Japan, services allowing users to browse content on mobile phones are in operation. One of such services is i-mode (trademark). To select link information on a mobile phone, numerical keys are used. Accordingly, in i-mode content, numbers corresponding to numerical keys are shown together with respective links. To display numbers in association with links, however, the correspondence between the links and the numerical keys needs to be predefined in the content. Thus, not all content on the Internet is displayed in a manner such that links are associated with numbers corresponding to the numerical keys.

As a method of facilitating the selection of link information in hypertext, Japanese Unexamined Patent Publication No. 2000-207089 discloses a technique of displaying an auxiliary input area in response to the display of a main input area for hypertext links. This technique makes it easy to distinguish link display portions on the screen.

However, according to the invention described in this publication, the correspondence between hypertext links in the main input area and respective navigation buttons in the auxiliary input area is indicated using different colors only. Thus, if hypertext links cannot be distinguished by color only, then it is difficult to find the hypertext links corresponding to the navigation buttons. Also, the above publication exemplifies a technique of displaying an opaque navigation button next to an input area associated therewith. However, where a navigation button and an input area associated therewith are shown in the same color, the input area cannot be distinguished if the color used is the same as that of the background.

### SUMMARY OF THE INVENTION

The present invention was created in view of the above circumstances, and an object thereof is to provide document display program, method and device which permit link information in a document to be visually distinguished with ease, and a computer-readable recording medium recording the document display program.

To achieve the object, there is provided a document display program for displaying a document containing a link anchored to a different document. The document display program causes a computer to perform the process of extracting, when the document is input, link information including location information of a linked document and description content indicative of presence of a link, from the input document, generating an object corresponding to the extracted link information, and displaying the document together with the generated object in such a display form as to include the description content included in the corresponding link information.

Also, to achieve the above object, there is provided a document display method for displaying a document containing a link anchored to a different document. The document display method comprises the step of extracting, when the document is input, link information including location information of a linked document and description content indicative of presence of a link, from the input document, the step of generating an object corresponding to the extracted link information, and the step of displaying the document together with the generated object in such a display form as to include the description content included in the corresponding link information.

Further, to achieve the above object, there is provided a document display device for displaying a document containing a link anchored to a different document. The document display device comprises link information extraction means for extracting, when the document is input, link information including location information of a linked document and description content indicative of presence of a link, from the input document, object generation means for generating an object corresponding to the link information extracted by the link information extraction means, and display means for displaying the document together with the object generated by the object generation means in such a display form as to include the description content included in the corresponding link information.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram illustrating the invention applied to embodiments.

FIG. 2 is a diagram showing an exemplary system configuration of a first embodiment.

FIG. 3 is a diagram showing an exemplary hardware configuration of a client used in the first embodiment.

FIG. 4 is a block diagram illustrating functions of the client used in the first embodiment.

FIG. 5 is a diagram exemplifying a demonstrative list.

FIG. 6 is a flowchart illustrating a document display process according to the first embodiment.

FIG. 7 is a flowchart illustrating a menu screen creation process according to the first embodiment.

FIG. 8 is a flowchart illustrating a document modification process according to the first embodiment.

FIG. 9 is a diagram exemplifying a document.

FIG. 10 is a diagram showing an exemplary screen displayed when the document is browsed according to the first embodiment.

FIG. 11 is a block diagram illustrating functions of a client according to a second embodiment.

FIG. 12 is a diagram showing an exemplary data structure of a reference count table.

FIG. 13 is a flowchart illustrating a document display process according to the second embodiment.

FIG. 14 is a flowchart illustrating a menu screen creation process according to the second embodiment.

FIG. 15 is a diagram showing an exemplary screen displayed when the document is browsed according to the second embodiment.

FIG. 16 is a block diagram showing configuration of a client according to a third embodiment.

FIG. 17 is a flowchart illustrating a menu screen creation process according to the third embodiment.

FIG. 18 is a flowchart illustrating a document modification process according to the third embodiment.

FIG. 19 is a flowchart illustrating a link blinking process.

FIG. 20 is a diagram showing an exemplary screen displayed when the document is browsed according to the third embodiment.

FIG. 21 is a flowchart illustrating a menu screen creation process according to a fourth embodiment.

FIG. 22 is a diagram showing an exemplary screen displayed when the document is browsed according to the fourth embodiment.

FIG. 23 is a block diagram illustrating functions of a browser according to a fifth embodiment.

FIG. 24 is a flowchart illustrating a menu screen creation process according to the fifth embodiment.

FIG. 25 is a block diagram showing configuration of a browser according to a sixth embodiment.

FIG. 26 is a flowchart illustrating a document display process according to the sixth embodiment.

FIG. 27 is a flowchart illustrating a child link analysis process.

FIG. 28 is a flowchart illustrating a menu screen creation process according to the sixth embodiment.

FIG. 29 is a diagram showing an exemplary screen displayed when the document is browsed according to the sixth embodiment.

FIG. 30 is a block diagram showing configuration of a browser according to a seventh embodiment.

FIG. 31 is a flowchart illustrating a menu screen updating process.

FIG. 32 is a diagram showing an exemplary screen displayed when the document is browsed according to the seventh embodiment.

FIG. 33 is a diagram illustrating an exemplary case where a document screen and a menu screen are displayed on different devices.

### DESCRIPTION OF THE PREFERRED EMBODIMENTS

Embodiments of the present invention will be hereinafter described with reference to the drawings.

First, the invention applied to embodiments will be outlined, and then specific embodiments will be described in detail.

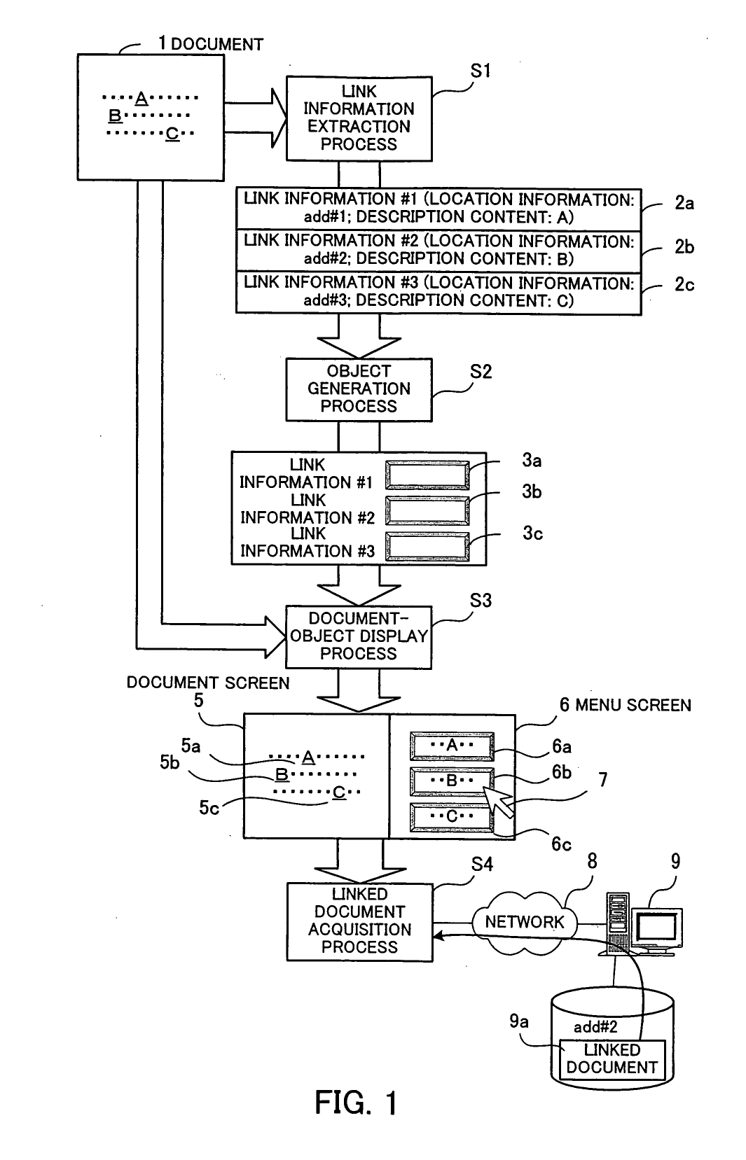

FIG. 1 is a conceptual diagram illustrating the invention applied to the embodiments. In FIG. 1, there is shown a process executed by a computer in accordance with a document display program for displaying a document 1 containing links anchored to different documents.

When the document 1 is input, the computer extracts, from the input document 1, link information items 2a to 2c each including location information of a linked document and description content indicative of the presence of a link (Step S1). In the example shown in FIG. 1, three link information items 2a to 2c are extracted from the document 1. The link information 2a (link information #1) includes location information “add#1” and description content “A”. The link information 2b (link information #2) includes location information “add#2” and description content “B”, and the link information 2c (link information #3) includes location information “add#3” and description content “C”.

Subsequently, the computer generates objects 3a to 3c corresponding to the extracted link information items 2a to 2c (Step S2). In the example of FIG. 1, the button objects 3a to 3c corresponding to the link information items 2a to 2c, respectively, are generated.

Further, the computer displays the document 1 together with the generated objects 3a to 3c in such display forms 6a to 6c as to include the description contents included in the respective link information items 2a to 2c (Step S3). In the example of FIG. 1, the document 1 is shown in a document screen 5. The displayed document 1 includes description contents 5a to 5c corresponding to the link information items 2a to 2c, respectively. The objects 3a to 3c are shown in a menu screen 6. The object 3a is displayed in the display form 6a so as to include the description content “A” included in the corresponding link information 2a. The object 3b is displayed in the display form 6b so as to include the description content “B” included in the corresponding link information 2b, and the object 3c is displayed in the display form 6c so as to include the description content “C” included in the corresponding link information 2c.

When an object is selected by an input operation, the computer acquires a linked document in accordance with the location information included in the link information corresponding to the selected object (Step S4). In the example of FIG. 1, a mouse pointer 7 manipulated by the user points to the display form 6b of the object 3b, and the object 3b is selected as soon as the mouse button is depressed. Thereupon, in accordance with the location information “add#2”, included in the link information 2b corresponding to the object 3b, a linked document 9a is acquired. The linked document 9a is, for example, a document stored in a different computer 9 connected via a network 8.

In this manner, the display forms 6a to 6c including the description contents of the link information items 2a to 2c are displayed together with the document 1, thus enabling the user to visually recognize with ease that the link information items 2a to 2c are included in the document 1.

Even if the description contents 5a to 5c of the link information items 2a to 2c, shown in the document screen 5, are underlined, for example, the user is unable, by just browsing the document 1, to recognize that the underlining is not mere emphasis but indicates the presence of links. Since the menu screen 6 is also displayed, the user can ascertain, by referring to the display forms 6a to 6c of the objects 3a to 3c, that link information has been set for the corresponding description contents 5a to 5c in the document screen 5. Namely, since the objects including the same description contents as the description contents 5a to 5c in the document screen 5 are displayed, the user can visually distinguish the presence of the link information items 2a to 2c corresponding to the description contents 5a to 5c.

To indicate more clearly the presence of the link information items 2a to 2c, the functions described below may be added.

When displaying an object, it is determined whether or not the description content thereof clearly indicates the content of the linked document. If it is judged that the description content does not clearly indicate the content of the linked document, text surrounding the description content may be included in the display form of the object. For example, in the case where the description content is a demonstrative, it is judged that the description content does not clearly indicate the content of the linked document. This permits the user to presume, by referring to the display form of the object, the content of the linked document to be acquired in accordance with the corresponding link information.

In the case where a plurality of link information items are extracted, link information items of which a predetermined part (e.g., part identifying a computer storing a linked document) of the location information is identical may be grouped together, and objects corresponding to the extracted link information items may be displayed in groups. This allows the user to accurately locate a linked document containing desired information.

Also, when the document is input, linkage may be traced forward a predetermined number of times from the link information extracted from the input document to pre-read relevant documents, and the link information-related objects (relevant objects) in the relevant documents may be displayed. In this case, even if a plurality of links must be followed to reach a target document containing desired information, the user can locate the target document without the need to follow the links one by one. As a result, the operational efficiency improves. When displaying the relevant objects, the linkage of documents may be shown using a tree structure. This allows the user to readily grasp the relevancy of documents and to find a target document with ease.

When an object is specified as a possible selection, the linked document may be pre-read in accordance with the location information included in the link information corresponding to the specified object, and objects (linked document correspondence objects) corresponding to link information items in the pre-read linked document may be displayed. In this case, linked document correspondence objects which are culled by the user are displayed, permitting the user to easily find an object corresponding to a document containing desired information.

Documents called hypertext or structured documents are known as documents containing link information anchored to different documents. These types of document are standardized as HTML or XML and are used in content delivered through the Internet. Thus, several embodiments of the present invention will be described in detail with reference to an exemplary case where content acquired via the Internet is displayed by a computer to which the present invention is applied.

### First Embodiment

In the first embodiment, buttons corresponding to the link information items included in the displayed document are listed in a separate menu screen in order of occurrence in the document. The buttons displayed in the menu screen show character strings (description contents) corresponding to the respective link information items. However, if the character string corresponding to link information constitutes a demonstrative (e.g., “here”, “there”, etc.), text (e.g., entire paragraph) surrounding the character string is also shown on the button. In the following, the first embodiment of the present invention will be described in detail.

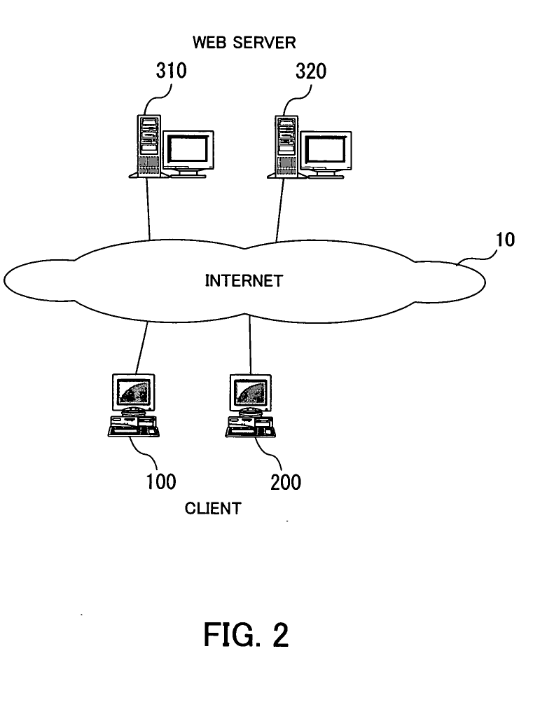

FIG. 2 shows an exemplary system configuration of the first embodiment. As shown in FIG. 2, a plurality of clients 100, 200 and a plurality of web servers 310, 320 are interconnected by the Internet 10.

The clients 100, 200 each have the function of acquiring web content, such as an HTML or XML document and image data specified in the document, and allowing the user to browse the content. The function of acquiring web content is accomplished by the communication function of TCP/IP (Transmission Control Protocol/Internet Protocol), for example. The function of allowing the user to browse content is accomplished by a browse function called browser. The browser of the first embodiment can display not only content but also a menu screen showing a list of link information items anchored to different documents.

The web servers 310, 320 are each a computer for delivering a variety of content.

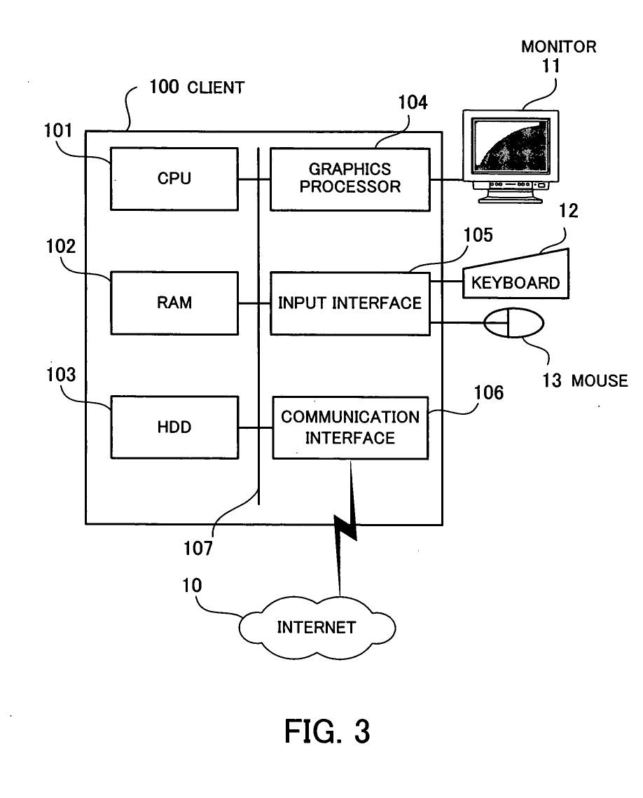

FIG. 3 shows an exemplary hardware configuration of a client used in the first embodiment. The client 100 is in its entirety under the control of a CPU (Central Processing Unit) 101. The CPU 101 is connected through a bus 107 with a RAM (Random Access Memory) 102, a hard disk drive (HDD) 103, a graphics processor 104, an input interface 105, and a communication interface 106.

The RAM 102 temporarily stores OS (Operating System) programs and at least part of application programs executed by the CPU 101. Also, the RAM 102 stores various other data necessary for the processing by the CPU 101. The HDD 103 stores the OS and application programs.

The graphics processor 104 is connected with a monitor 11. In accordance with instructions from the CPU 101, the graphics processor 104 causes the monitor 11 to display images on a screen thereof. The input interface 105 is connected with a keyboard 12 and a mouse 13. The input interface 105 supplies signals from the keyboard 12 and the mouse 13 to the CPU 101 via the bus 107.

The communication interface 106 is connected to the Internet 10 and transmits/receives data to/from other computers via the Internet 10.

Processing functions of the first embodiment can be performed by the hardware configuration described above. Although FIG. 3 shows the hardware configuration of the client 100, the other client 200 and web servers 310, 320 may have a similar hardware configuration.

The functions according to the first embodiment are incorporated in the browser of the client 100.

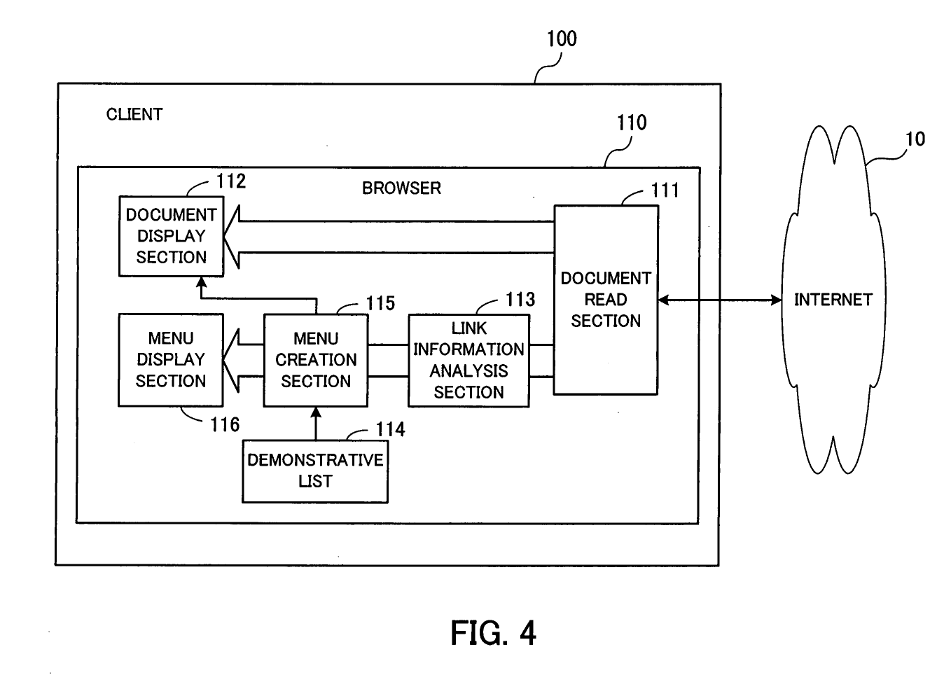

FIG. 4 is a block diagram illustrating the functions of the client according to the first embodiment. A browser 110 is installed on the client 100. The browser 110 has a document read section 111, a document display section 112, a link information analysis section 113, a demonstrative list 114, a menu creation section 115, and a menu display section 116. These elements have connective relations such that those elements which exchange information are connected with each other. The connective relation referred to herein means that arrangements are made between the connected elements for the transfer of information.

Specifically, the document read section 111 is connected to the Internet 10, the document display section 112 and the link information analysis section 113. The document display section 112 is connected to the menu creation section 115, besides the element 111. The link information analysis section 113 is connected to the menu creation section 115, besides the element 111. The menu creation section 115 is connected to the demonstrative list 114 and the menu display section 116, besides the elements 112 and 113.

In response to an input operation of the user, the document read section 111 reads in a document (HTML document, image data, etc.) via the Internet 10. The input operation which triggers the document read operation is, for example, the entry of the location (URL etc.) of an HTML document which is under the management of the web server 310, 320, or the selection of link information in the displayed document anchored to a different document. The document read section 111 transfers the read document to the document display section 112 and the link information analysis section 113.

The document display section 112 displays the document received from the document read section 111 on the screen of the monitor 11. Also, in response to an editing operation of the document (e.g., HTML document) by the menu creation section 115, the document display section 112 modifies the contents of the document to be displayed. Specifically, numbers (identification information) associated with buttons displayed by the menu display section 116 are inserted in respective link information items in the displayed document.

On receiving the document from the document read section 111, the link information analysis section 113 analyzes the document. Specifically, first, the link information analysis section 113 extracts link information from the document. Then, the link information analysis section 113 identifies, with respect to the extracted link information, location information specifying a linked document and description content of the corresponding link in the document.

If the document is an HTML document, the link information is described in the part (anchor element) enclosed by anchor tags (<A></A>). For example, the link information is described as follows: <A HREF=“http://f-tsu.com/index.html”>F-tsu Kabushiki Kaisha<A/>. In this instance, “http://f-tsu.com/index.html” described as the href attribute is the location information (URI: Uniform Resource Identifier) indicating the location of the linked document, and “F-tsu Kabushiki Kaisha” is the description content of the link.

On the other hand, if the document is an XML document, the link information is described as a link element as follows, for example: <companylink xlink:type=“simple” xlink:href=“http://www.f-tsu.com/index.xml”>F-tsu Kabushiki Kaisha</companylink>.

In this instance, “http://www.f-tsu.com/index.xml” described in the link element (xlink) is the URL indicating the location of the linked document, and “F-tsu Kabushiki Kaisha” is the description content of the link. Also, in XML, if the linked document is a remote source, the location information is described as the href attribute of a locator element.

The link information analysis section 113 transfers the analyzed document and the results of analysis to the menu creation section 115.

Based on the document and the results of analysis thereof received from the link information analysis section 113, the menu creation section 115 creates a menu showing a list of the link information items. The menu thus created includes buttons corresponding to the respective link information items, and the buttons are associated with respective linked documents. Also, each button shows the description content of the link set in the corresponding link information.

The menu creation section 115 also looks up the demonstrative list 114 to determine whether or not the description content of each link is a demonstrative. If the description content is a demonstrative, the menu creation section 115 acquires a character string (e.g., sentence or paragraph including the description content) surrounding the link information and sets the acquired character string as description content for the button to be shown in the menu.

Then, the menu creation section 115 transfers the created menu to the menu display section 116. Also, the menu creation section 115 assigns numbers to the respective buttons in the menu and includes the assigned numbers in the description contents of the corresponding buttons. Further, the menu creation section 115 edits the document transferred to the document display section 112, to insert the numbers in the document near the respective link information items.

The menu display section 116 displays the menu created by the menu creation section 115 on the screen. For example, the menu display section 116 opens a separate screen in an area that does not overlap with the display screen for the document displayed by the document display section 112 and displays the menu in that screen.

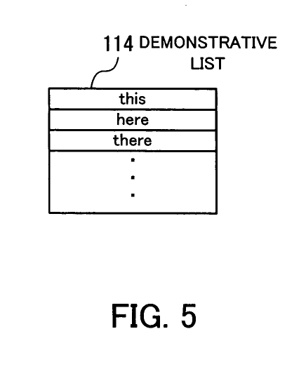

FIG. 5 shows an example of the demonstrative list. In the demonstrative list 114 are set character strings representing demonstratives. In the example of FIG. 5, “this”, “here”, “there”, etc. are set as demonstratives.

Using the client 100 configured as described above, a document is browsed, whereupon the content of the document is displayed together with a menu showing only links with different documents extracted from the document. In the following, the document display process performed by the client 100 will be described in detail.

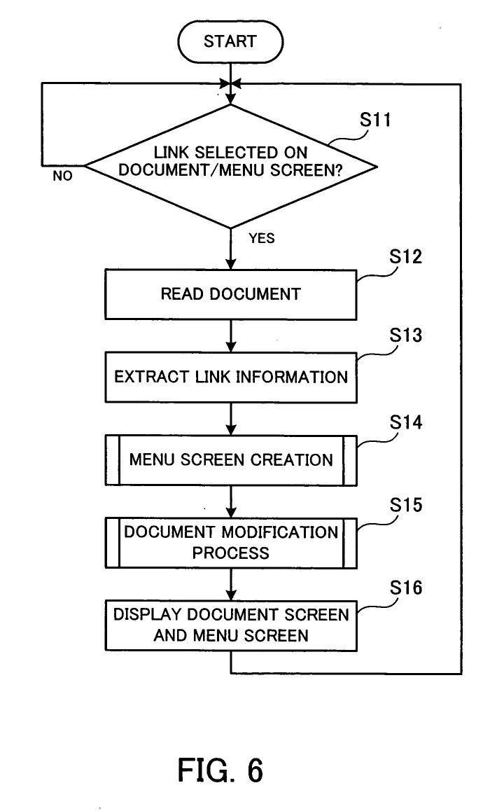

FIG. 6 is a flowchart illustrating the document display process according to the first embodiment. The process shown in FIG. 6 will be now described in order of step number.

[Step S11] The document read section 111 detects an input operation of the user by means of the mouse 13 or the like, and determines whether or not a link has been selected on the document/menu screen. If a link has been selected, the process proceeds to Step S12; if not, Step S11 is repeated.

[Step S12] The document read section 111 identifies the location of a linked document set with respect to the selected link and reads in the document from that location. Then, the document read section 111 transfers the read document to the document display section 112 and the link information analysis section 113.

[Step S13] The link information analysis section 113 analyzes the document and extracts link information therefrom. At this time, the link information analysis section 113 identifies location information of each linked document and description content of the corresponding link, set in the extracted link information. The link information analysis section 113 then transfers the document and the link information (location information of the linked documents and the description contents of the respective links), extracted as a result of the analysis, to the menu creation section 115.

[Step S14] The menu creation section 115 performs a menu screen creation process. The menu screen creation process will be described in detail later.

[Step S15] The menu creation section 115 performs a document modification process, which also will be described in detail later.

[Step S16] The document display section 112 displays the document modified by the menu creation section 115 on the monitor 11. Simultaneously, the menu display section 116 displays the menu screen created by the menu creation section 115 on the monitor 11. The process then proceeds to Step S11, in which the document read section 111 waits for subsequent selection of a link.

The menu screen creation process (Step S14 in FIG. 6) will be now described in detail.

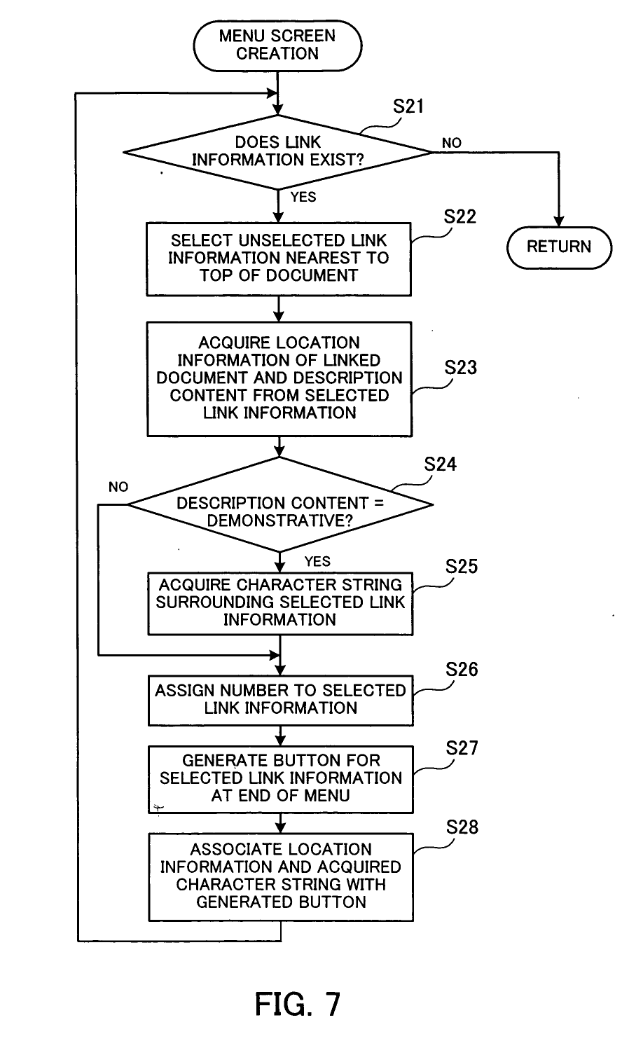

FIG. 7 is a flowchart illustrating the menu screen creation process according to the first embodiment. This process is executed by the menu creation section 115 when the document and the analysis results are received from the link information analysis section 113. In the following, the process shown in FIG. 7 will be explained in order of step number.

[Step S21] The menu creation section 115 determines whether or not there exists a link information item (unselected link information item) which is not yet processed in Step S22 and the succeeding steps, among the link information items extracted by the link information analysis section 113. If there is an unprocessed link information item, the process proceeds to Step S22; if all link information items have been processed, the process proceeds to Step S15 in FIG. 6.

[Step S22] The menu creation section 115 selects one unselected link information item which is nearest to the top of the document. Thus, the link information items are selected one by one in order from the top of the document.

[Step S23] The menu creation section 115 acquires, from the selected link information item, location information of a linked document and description content of the corresponding link.

[Step S24] The menu creation section 115 determines whether or not the description content is a demonstrative. Whether the description content is a demonstrative or not is determined by looking up the demonstrative list 114. Specifically, if the description content of the selected link information item is included in the demonstrative list 114, it is judged that the description content is a demonstrative. If the description content is a demonstrative, the process proceeds to Step S25; if not, the process proceeds to Step S26.

[Step S25] The menu creation section 115 acquires a character string surrounding the selected link information item. For example, a sentence including the link information is acquired.

[Step S26] The menu creation section 115 assigns a number to the selected link information item. For example, sequentially selected link information items are numbered in ascending order from “1”.

[Step S27] The menu creation section 115 generates a button for the selected link information item at the end of the menu being created. When the created menu is displayed on the screen, a button generated earlier is located nearer to the top of the screen and a button generated later is located nearer to the bottom of the screen.

[Step S28] The menu creation section 115 associates the location information and the acquired character string with the generated button. The associated location information indicates the location of the document which is to be acquired when the button is selected. The character string is the one acquired in Step S25 if Step S25 was executed, and is the character string of the description content acquired in Step S23 if Step S25 was skipped. The process then proceeds to Step S21.

The document modification process (Step S15 in FIG. 6) will be now described in detail.

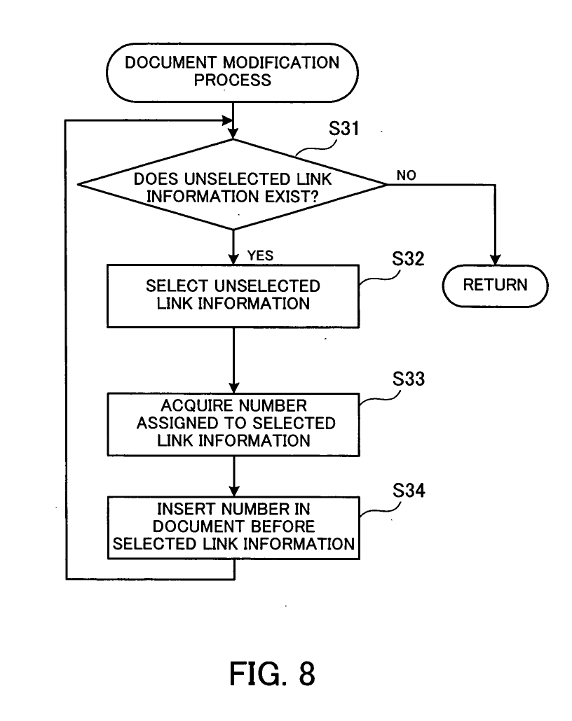

FIG. 8 is a flowchart illustrating the document modification process according to the first embodiment. In the following, the process shown in FIG. 8 will be described in order of step number.

[Step S31] The menu creation section 115 determines whether or not there exists a link information item (unselected link information item) which is not yet processed in Step S32 and the succeeding steps, among the link information items extracted by the link information analysis section 113. If there is an unprocessed link information item, the process proceeds to Step S32; if all link information items have been processed, the process proceeds to Step S16 in FIG. 6.

[Step S32] The menu creation section 115 selects one unselected link information item.

[Step S33] The menu creation section 115 acquires the number assigned in the menu screen creation process with respect to the selected link information item.

[Step S34] The menu creation section 115 inserts the number acquired in Step S33 into the document at a location before the selected link information item. The process then proceeds to Step S31.

Due to the above process, a menu screen showing only the link information items extracted from the document is created.

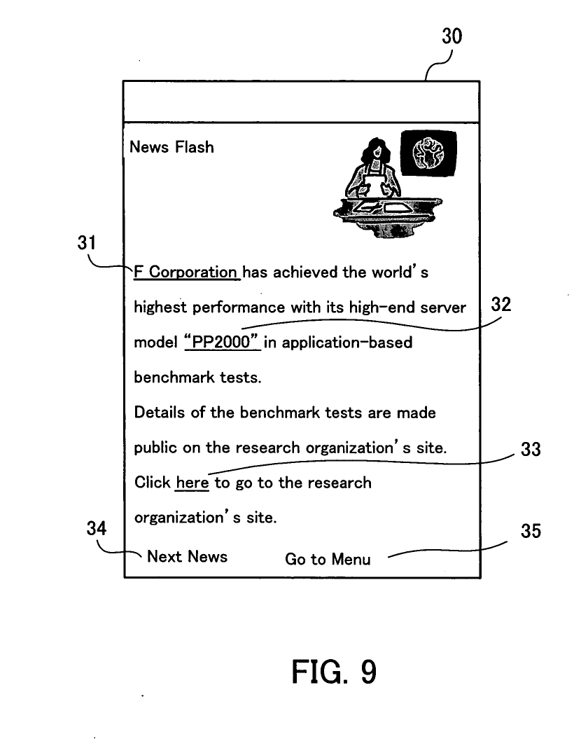

FIG. 9 shows an exemplary document. In FIG. 9, an exemplary case is shown where a document 30 delivered as a news flash is displayed on a conventional browser. The document 30 contains the following text: “F Corporation has achieved the world's highest performance with its high-end server model ‘PP2000’ in application-based benchmark tests. Details of the benchmark tests are made public on the research organization's site. Click here to go to the research organization's site.” The text includes three link information items 31 to 33, each of which is underlined. The description content of the link information item 31 is “F Corporation”. The description content of the link information item 32 is “PP2000”, and the description content of the link information item 33 is “here”. The document 30 also includes a link information item 34 with the description “Next News”, and a link information item 35 with the description “Go to Menu”.

A document like the illustrated document 30 is acquired by the client 100 and input to the browser 110, whereupon the document screen and the menu screen are displayed.

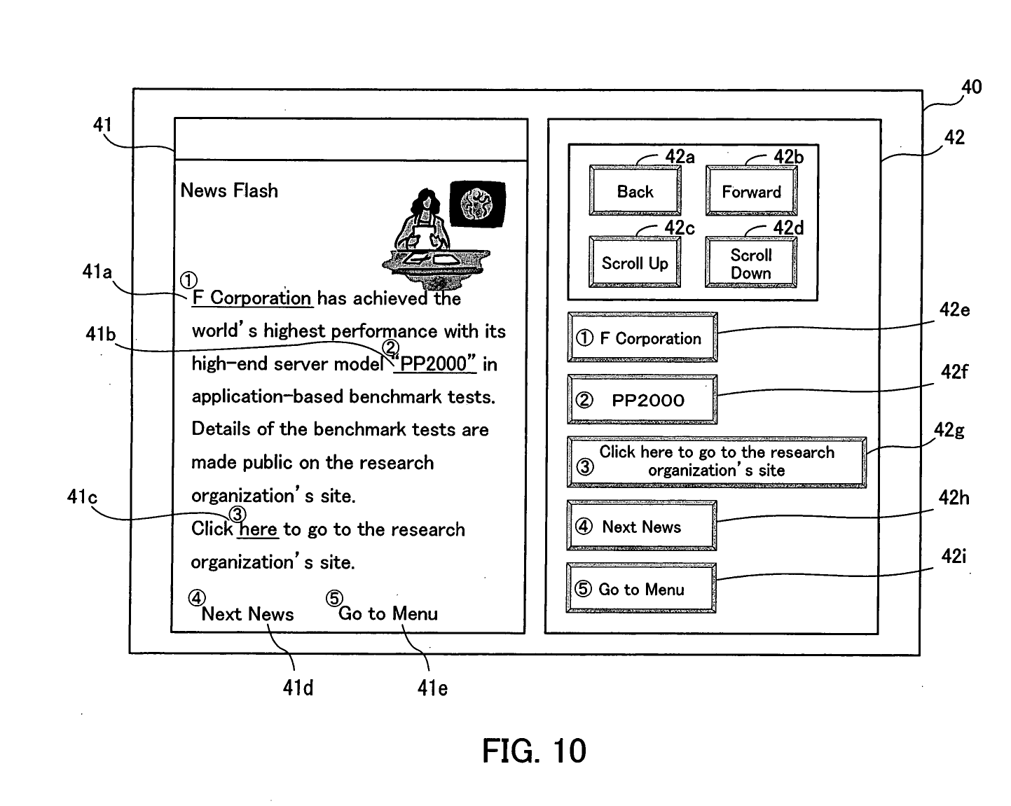

FIG. 10 shows an exemplary screen displayed when the document is browsed according to the first embodiment. A document screen 41 and a menu screen 42 are displayed on the screen 40 of the monitor 11.

The content of the document is shown in the document screen 41. In the document screen 41, numbers assigned to respective link information items 41a to 41e are displayed at the upper left of the description contents of the corresponding link information items 41a to 41e. The numbers “1”, “2”, “3”, “4” and “5” are assigned to the link information items 41a, 41b, 41c, 41d and 41e, respectively.

A plurality of buttons 42a to 42i are shown in the menu screen 42. Of these, the four buttons 42a to 42d are displayed irrespective of the link information in the document. The button 42a labeled “Back” is used to return to the previous screen. The button 42b labeled “Forward” is used to proceed to the next screen (the button can be used only when the “Back” button has been depressed on the screen once visited). The button 42c labeled “Scroll Up” is used to scroll up the document screen 41, and the button 42d labeled “Scroll Down” is used to scroll down the document screen 41.

The button 42e with the description “F Corporation” corresponds to the link information item 41a. The number “1”, which is the same as that assigned to the link information item 41a, is shown on the button 42e. If the button 42e is selected, a document corresponding to the link information item 41a is acquired.

The button 42f with the description “PP2000” corresponds to the link information item 41b. The number “2”, which is the same as that assigned to the link information item 41b, is shown on the button 42f. If the button 42f is selected, a document corresponding to the link information item 41b is acquired.

The button 42g with the description “Click here to go to the research organization's site” corresponds to the link information item 41c. Since the description content “here” of the link information item 41c is a demonstrative, the sentence including the link information item 41c is shown on the button 42g. Also, the number “3”, which is the same as that assigned to the link information item 41c, is shown on the button 42g. If the button 42g is selected, a document corresponding to the link information item 41c is acquired.

The button 42h with the description “Next News” corresponds to the link information item 41d. The number “4”, which is identical with that assigned to the link information item 41d, is shown on the button 42h. If the button 42h is selected, a document corresponding to the link information item 41d is acquired.

The button 42i with the description “Go to Menu” corresponds to the link information item 41e. The number “5”, which is identical with that assigned to the link information item 41e, is shown on the button 42i. If the button 42i is selected, a document corresponding to the link information item 41e is acquired.

In this manner, the document screen 41 and the menu screen 42 are displayed side by side, whereby the user can readily notice, by viewing the menu screen 42, the presence of link information that may otherwise be difficult to visually distinguish on the document screen 41. Namely, even if the acquired hypertext or structured document is of a kind inattentive to menu, the user can readily understand what operations can be performed next on such documents, thus facilitating the user's manipulation.

Moreover, the link information items and the buttons corresponding thereto are shown using the same numbers, and this enables the user to readily recognize the correspondence between the buttons and the respective link information items. Further, the buttons show the description contents set in the respective link information items, and this permits the user to guess at a glance what documents the respective buttons are linked with. For example, if “F Corporation” is shown on a button, the user readily understands that the button is linked with the F Corporation's page.

Also, if the description content set in link information is a demonstrative, a character string surrounding the demonstrative is also shown on the button. Thus, even in the case where the description content of link information is a demonstrative, a meaningful character string etc. indicating the linked document is shown on the corresponding button.

Further, the buttons 42e to 42i are displayed in the menu screen 42 in order of occurrence of the corresponding link information items in the document, and this allows the user to easily find the link information items in the document corresponding to the respective buttons.

### Second Embodiment

The second embodiment will be now described. In the second embodiment, the buttons are arranged in the menu screen in accordance with reference counts of linked documents. The system configuration and hardware configuration used in the second embodiment are identical with those of the first embodiment shown in FIGS. 2 and 3, respectively.

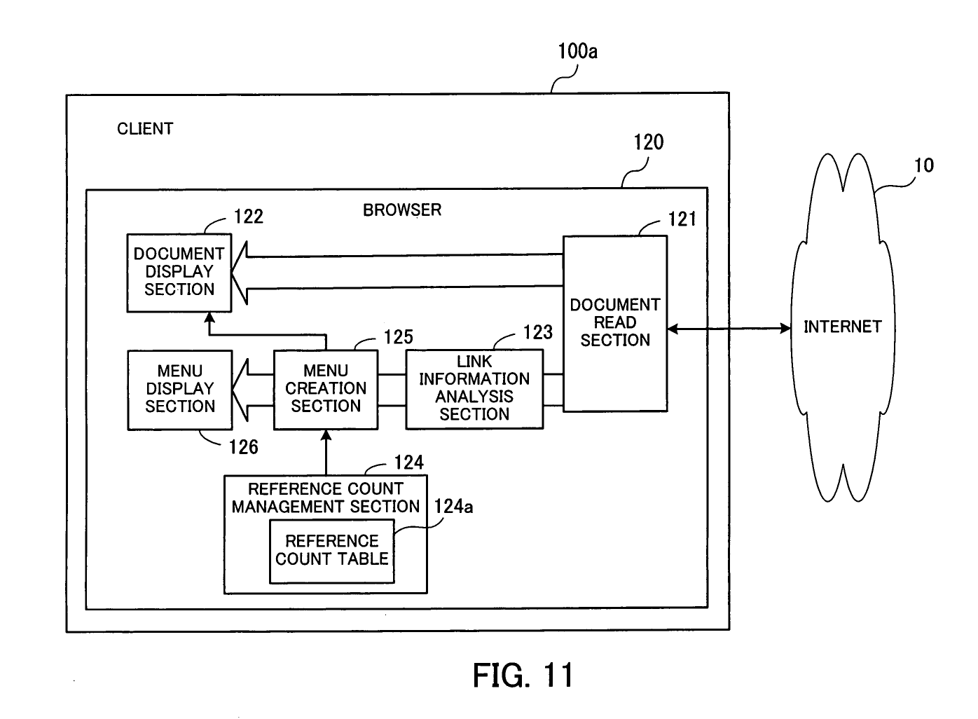

FIG. 11 is a block diagram illustrating functions of a client according to the second embodiment. A browser 120 configured as shown in FIG. 11 is installed on the client 100a of the second embodiment. The browser 120 has a document read section 121, a document display section 122, a link information analysis section 123, a reference count management section 124, a menu creation section 125, and a menu display section 126. The document read section 121, the document display section 122, the link information analysis section 123 and the menu display section 126 have the same functions as those with the same names of the first embodiment shown in FIG. 4.

The reference count management section 124 detects an input operation of the user on the screen of the browser 120 and manages the counts or the numbers of times respective documents are referred to. The reference counts of the individual documents are stored in a reference count table 124a. Each time the document read section 121 reads in a document, the reference count management section 124 increments the reference count in the reference count table 124a corresponding to the read document. If no reference count is registered with respect to the read document in the reference count table 124a, the reference count management section 124 adds a reference count for the read document and registers “1” in the reference count table 124a as the added reference count. Also, at the request of the menu creation section 125, the reference count management section 124 notifies the menu creation section 125 of the reference counts of the documents.

The menu creation section 125 has a function almost identical with that of the menu creation section 115 of the first embodiment shown in FIG. 4. In the second embodiment, however, the menu creation section 125 arranges buttons in the menu not in order of occurrence in the document, but in descending order of reference counts. To this end, on receiving the document and the analysis results thereof from the link information analysis section 123, the menu creation section 125 inquires of the reference count management section 124 about the reference counts of documents included in the analysis results as the location information of linked documents. Then, the menu creation section 125 creates a menu in which the buttons are arranged in descending order of reference counts.

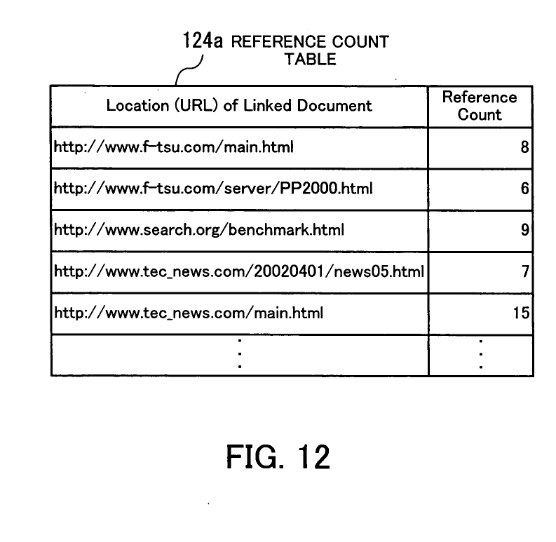

FIG. 12 shows an exemplary data structure of the reference count table. The reference count table 124a has columns labeled “Location (URL) of Linked Document” and “Reference Count”. In the column “Location (URL) of Linked Document”, the location information of read documents is set. In the example of FIG. 12, the location information is indicated by URL. In the column “Reference Count”, the document reference count is set in association with the corresponding location information.

The reference count table 124a of FIG. 12 shows, by way of example, the reference counts of the documents corresponding to the link information items 31 to 35 included in the document 30 shown in FIG. 9.

For the link information item 31 with the description “F Corporation”, “http://www.f-tsu.com/main.html” is set as the location of the linked document and the reference count of this document is “8”. For the link information item 32 with the description “PP2000”, “http://www.f-tsu.com/server/PP2000.html” is set as the location of the linked document and the reference count of this document is “6”. For the link information item 33 with the description “here”, “http://www.search.org/benchmark.html” is set as the location of the linked document and the reference count of this document is “9”. For the link information item 34 with the description “Next News”, “http://www.tec_news.com/20020401/news05.html” is set as the location of the linked document and the reference count of this document is “7”. For the link information item 35 with the description “Go to Menu”, “http://www.tec_news.com/main.html” is set as the location of the linked document and the reference count of this document is “15”.

The process performed by the browser 120 configured as above will be now described.

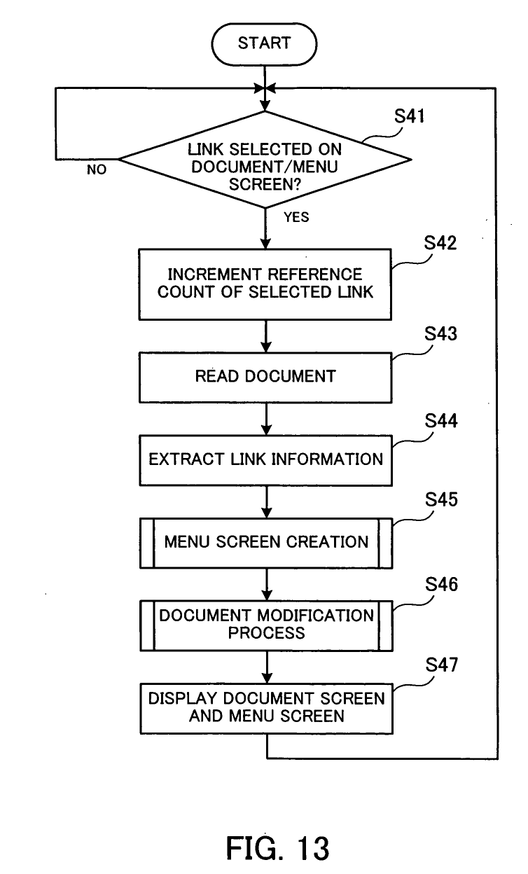

FIG. 13 is a flowchart illustrating the document display process according to the second embodiment. In the following, the process shown in FIG. 13 will be explained in order of step number.

[Step S41] The document read section 121 detects an input operation of the user by means of the mouse 13 or the like, and determines whether or not a link has been selected on the document/menu screen. If a link has been selected, the process proceeds to Step S42; if not, Step S41 is repeated.

[Step S42] The reference count management section 124 increments, by “1”, the reference count of the selected link set in the reference count table 124a. If the selected link is not set in the reference count table 124a as a linked document, the reference count management section 124 sets the location information of the linked document under the column “Location (URL) of Linked Document” of the reference count table 124a and sets “1” as the reference count therefor.

[Step S43] The document read section 121 identifies the location of the linked document set with respect to the selected link and reads in the document from that location. Then, the document read section 121 transfers the read document to the document display section 122 and the link information analysis section 123.

[Step S44] The link information analysis section 123 analyzes the document and extracts link information therefrom. At this time, the link information analysis section 123 identifies location information of each linked document and description content of the corresponding link, set in the extracted link information. The link information analysis section 123 then transfers the document and the analysis results thereof to the menu creation section 125.

[Step S45] The menu creation section 125 performs a menu screen creation process, described in detail later.

[Step S46] The menu creation section 125 performs a document modification process. The document modification process is identical with that of the first embodiment, explained in detail with reference to FIG. 8.

[Step S47] The document display section 122 displays the document modified by the menu creation section 125 on the monitor 11. Simultaneously, the menu display section 126 displays the menu screen created by the menu creation section 125 on the monitor 11. The process then proceeds to Step S41, in which the document read section 121 waits for subsequent selection of a link.

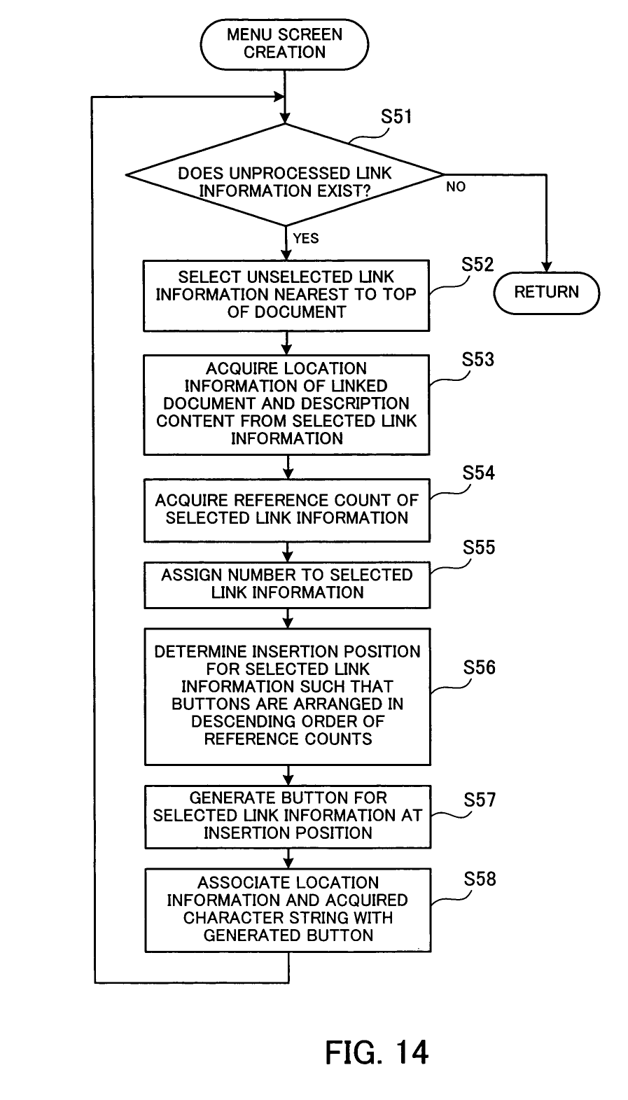

FIG. 14 is a flowchart illustrating the menu screen creation process according to the second embodiment. This process is executed by the menu creation section 125 when the document and the analysis results are received from the link information analysis section 123. In the following, the process shown in FIG. 14 will be explained in order of step number.

[Step S51] The menu creation section 125 determines whether or not there exists a link information item (unselected link information item) which is not yet processed in Step S52 and the succeeding steps, among the link information items extracted by the link information analysis section 123. If there is an unprocessed link information item, the process proceeds to Step S52; if all link information items have been processed, the process proceeds to Step S46 in FIG. 13.

[Step S52] The menu creation section 125 selects one unselected link information item which is nearest to the top of the document. Thus, the link information items are selected one by one in order from the top of the document.

[Step S53] The menu creation section 125 acquires, from the selected link information item, location information of a linked document and description content of the corresponding link.

[Step S54] The menu creation section 125 acquires, from the reference count management section 124, the reference count of the linked document corresponding to the selected link information item.

[Step S55] The menu creation section 125 assigns a number to the selected link information item. For example, sequentially selected link information items are numbered in ascending order from “1”.

[Step S56] The menu creation section 125 determines the insertion position of a button for the selected link information item such that the buttons are arranged in descending order of reference counts.

[Step S57] The menu creation section 125 generates the button for the selected link information item at the insertion position determined in Step S56.

[Step S58] The menu creation section 125 associates the location information and the acquired character string with the generated button. The associated location information indicates the location of the document which is to be acquired when the button is selected. The character string is the character string of the description content acquired in Step S53. The process then proceeds to Step S51.

In this manner, the buttons are arranged in the menu screen in descending order of reference counts of the documents corresponding thereto.

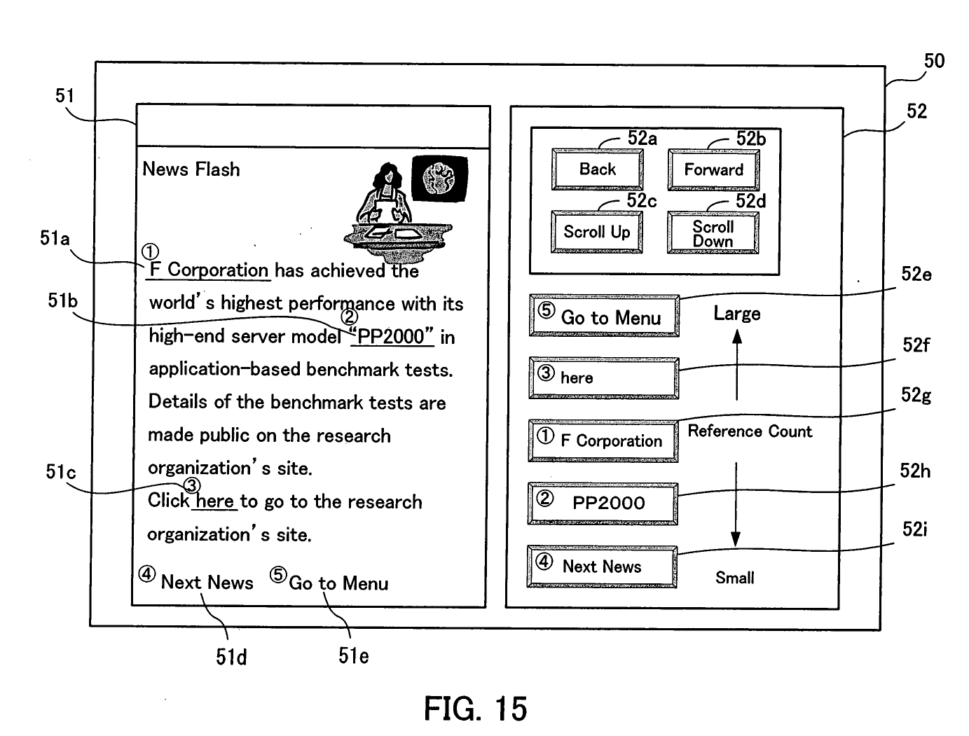

FIG. 15 shows an exemplary screen displayed when the document is browsed according to the second embodiment. A document screen 51 and a menu screen 52 are displayed on the screen 50 of the monitor 11.

The document screen 51 shows the content of the document. In the document screen 51, numbers assigned to respective link information items 51a to 51e are displayed at the upper left of the description contents of the corresponding link information items 51a to 51e. The numbers “1”, “2”, “3”, “4” and “5” are assigned to the link information items 51a, 51b, 51c, 51d and 51e, respectively.

The menu screen 52 shows a plurality of buttons 52a to 52i. Of these, the four buttons 52a to 52d are displayed irrespective of the link information in the document. The functions of the buttons 52a to 52d are identical with those of the respective buttons 42a to 42d of the first embodiment explained above with reference to FIG. 10.

The buttons 52e to 52i are arranged in descending order of reference counts of the respective linked documents. In the example of FIG. 15, the buttons are arranged in order, from top of the screen, of: the button 52e with the description “Go to Menu”, the button 53f with the description “here”, the button 52g with the description “F Corporation”, the button 52h with the description “PP2000”, and the button 52i with the description “Next News”. The buttons 52e to 52i also show the numbers assigned to the corresponding link information items.

In this manner, according to the second embodiment, the buttons 52e to 52i are arranged in the menu screen 52 in descending order of reference counts. Thus, if all buttons cannot be shown in one screen, buttons of larger reference counts are preferentially displayed on the initial menu screen 52. As a result, buttons with higher possibilities of being selected by the user are preferentially displayed on the menu screen 52, whereby the operational efficiency at the time of browsing documents on the browser 120 improves.

In the second embodiment, the demonstrative “here” is directly used as the description content of the button 52f. Like the first embodiment, however, a character string surrounding the demonstrative may be included in the description content of the button 52f.

### Third Embodiment

In the third embodiment, when a desired button in the menu screen is specified as a possible selection, the link in the document screen corresponding to the button specified as the possible selection is highlighted. When the mouse pointer is placed over a button, it is judged that the button is specified as a possible selection. Also, in the third embodiment, a link in the document screen corresponding to the button specified as a possible selection is highlighted by blinking.

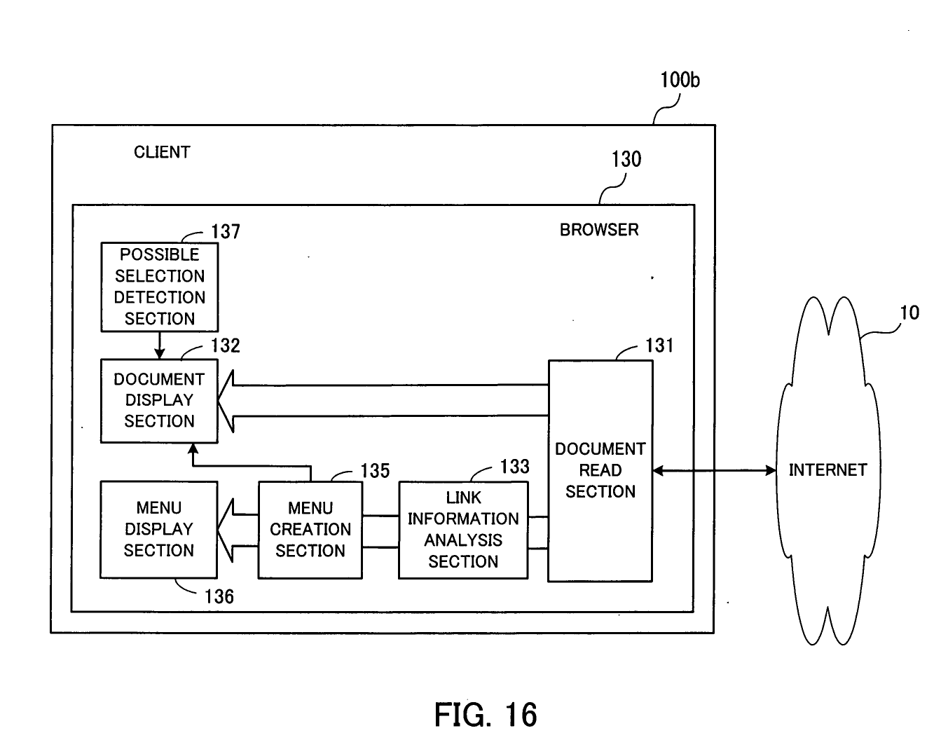

FIG. 16 is a block diagram showing the configuration of a client according to the third embodiment. A browser 130 configured as shown in FIG. 16 is installed on the client 100b of the third embodiment. The browser 130 has a document read section 131, a document display section 132, a link information analysis section 133, a menu creation section 135, a menu display section 136, and a possible selection detection section 137. The document read section 131, the document display section 132, the link information analysis section 133 and the menu display section 136 have the same functions as those with the same names of the first embodiment explained above with reference to FIG. 4.

The menu creation section 135 has a function similar to that of the menu creation section 115 of the first embodiment. However, even if the description content of link information is a demonstrative, the menu creation section 135 displays the description content as it stands on the corresponding button in the menu screen. Also, the menu creation section 135 sets identification information with respect to each of the link information items in the document read from the link information analysis section 133. As such identification information, the link information items are serially numbered in order from the top of the document, for example. Then, the menu creation section 135 associates the identification information of each link information item with a button for the corresponding link information item in the menu. Also, the menu creation section 135 edits the document transferred to the document display section 132 such that the identification information of each link information item is associated, as non-display information, with the corresponding link information item in the document.

The possible selection detection section 137 monitors the on-screen position of the mouse pointer, to detect the movement of the mouse pointer to a position over any of the buttons in the menu screen (only the buttons corresponding to the respective link information items in the document). The possible selection detection section 137 then extracts the identification information associated with the button pointed with the mouse pointer and transfers the extracted identification information to the document display section 132.

The document display section 132 has the function described below, in addition to the function of the document display section 112 of the first embodiment shown in FIG. 4. Namely, on acquiring, from the possible selection detection section 137, the identification information associated with the button specified as a possible selection, the document display section 132 detects link information corresponding to the identification information, and then causes the description content of the detected link information to blink on the document screen.

The browser 130 configured as above performs the process described below. A general procedure of the process performed by the browser 130 is identical with that of the first embodiment shown in FIG. 6.

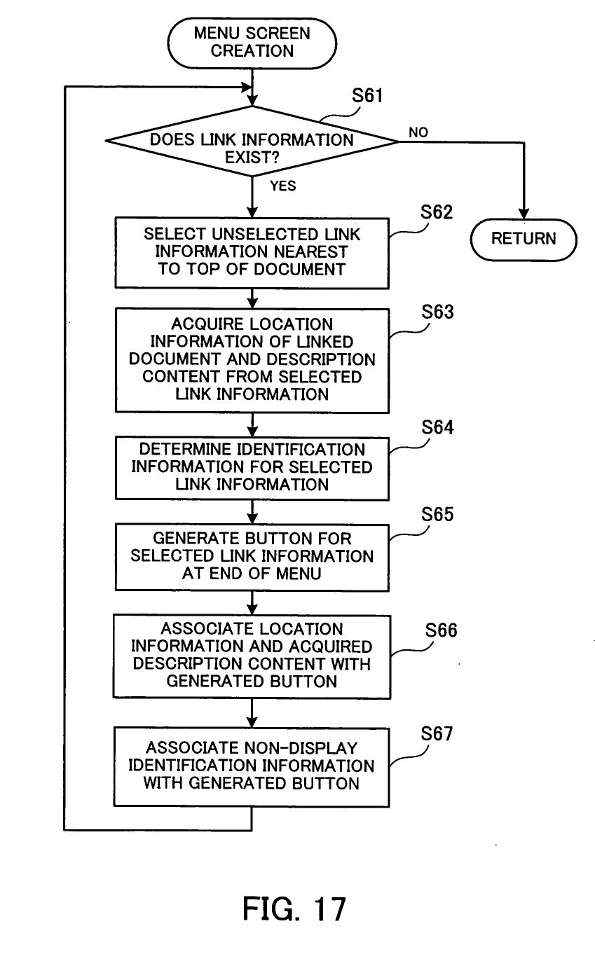

FIG. 17 is a flowchart illustrating a menu screen creation process according to the third embodiment. In the following, the process shown in FIG. 17 will be explained in order of step number.

[Step S61] The menu creation section 135 determines whether or not there exists a link information item (unselected link information item) which is not yet processed in Step S62 and the succeeding steps, among the link information items extracted by the link information analysis section 133. If there is an unprocessed link information item, the process proceeds to Step S62; if all link information items have been processed, the process proceeds to Step S15 in FIG. 6.

[Step S62] The menu creation section 135 selects one unselected link information item which is nearest to the top of the document. Thus, the link information items are selected one by one in order from the top of the document.

[Step S63] The menu creation section 135 acquires, from the selected link information item, location information of a linked document and description content of the corresponding link.

[Step S64] The menu creation section 135 determines identification information for the selected link information item. For example, as link information items are sequentially selected, numbers are assigned in ascending order from “1”.

[Step S65] The menu creation section 135 generates a button for the selected link information item at the end of the menu being created. When the created menu is displayed on the screen, a button generated earlier is located nearer to the top of the screen and a button generated later is located nearer to the bottom of the screen.

[Step S66] The menu creation section 135 associates the location information and the acquired description content with the generated button. The associated location information indicates the location of the document which is to be acquired when the button is selected.

[Step S67] The menu creation section 135 associates, as non-display information, the identification information determined in Step S64 with the generated button. The process then proceeds to Step S61.

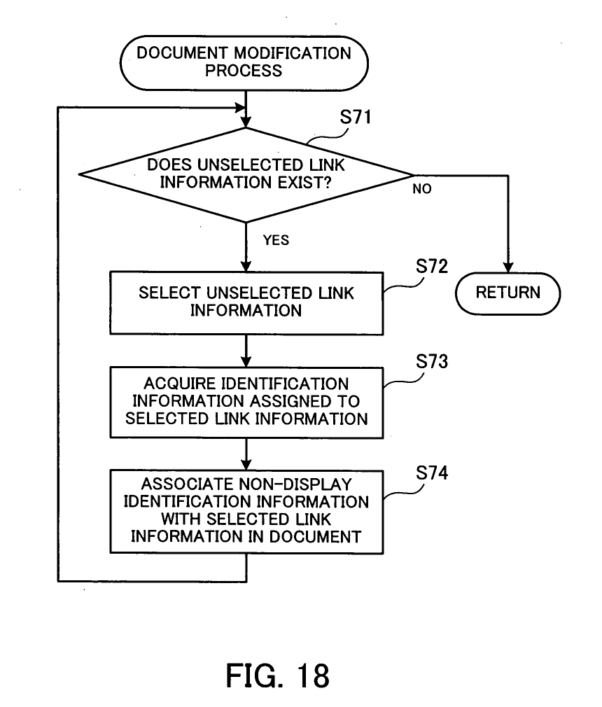

FIG. 18 is a flowchart illustrating a document modification process according to the third embodiment. In the following, the process shown in FIG. 18 will be explained in order of step number.

[Step S71] The menu creation section 135 determines whether or not there exists a link information item (unselected link information item) which is not yet processed in Step S72 and the succeeding steps, among the link information items extracted by the link information analysis section 133. If there is an unprocessed link information item, the process proceeds to Step S72; if all link information items have been processed, the process proceeds to Step S16 in FIG. 6.

[Step S72] The menu creation section 135 selects one unselected link information item.

[Step S73] The menu creation section 135 acquires the identification information assigned in the menu screen creation process with respect to the selected link information item.

[Step S74] The menu creation section 135 associates, as non-display information, the identification information acquired in Step S73 with the selected link information item in the document. The process then proceeds to Step S71.

In this manner, each link information item in the document screen and the corresponding button in the menu screen are associated with each other by means of non-display identification information. Then, the document screen is displayed by the document display section 132 and the menu screen is displayed by the menu display section 136. When a button in the menu screen is specified as a possible selection, the description content of the link information item corresponding to the specified button blinks.

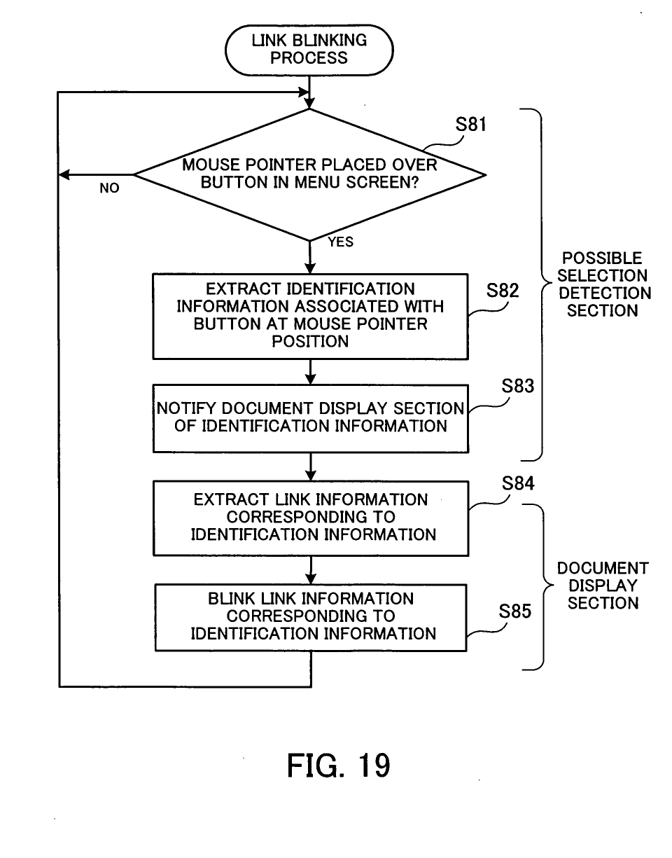

FIG. 19 is a flowchart illustrating the link blinking process. This process is continuously executed while the document screen and the menu screen are displayed on the monitor 11. In the following, the process shown in FIG. 19 will be explained in order of step number.

[Step S81] The possible selection detection section 137 determines whether or not the mouse pointer is placed over any of the buttons (only the buttons corresponding to the link information items) shown in the menu screen. If the mouse pointer is placed over any of the buttons, the process proceeds to Step S82; if not, Step S81 is repeated.

[Step S82] The possible selection detection section 137 extracts the identification information associated with the button over which the mouse pointer is placed.

[Step S83] The possible selection detection section 137 notifies the document display section 132 of the identification information.

[Step S84] The document display section 132 extracts the link information item associated with the identification information notified from the possible selection detection section 137.

[Step S85] The document display section 132 causes the extracted link information item to blink on the screen. The process then proceeds to Step S81.

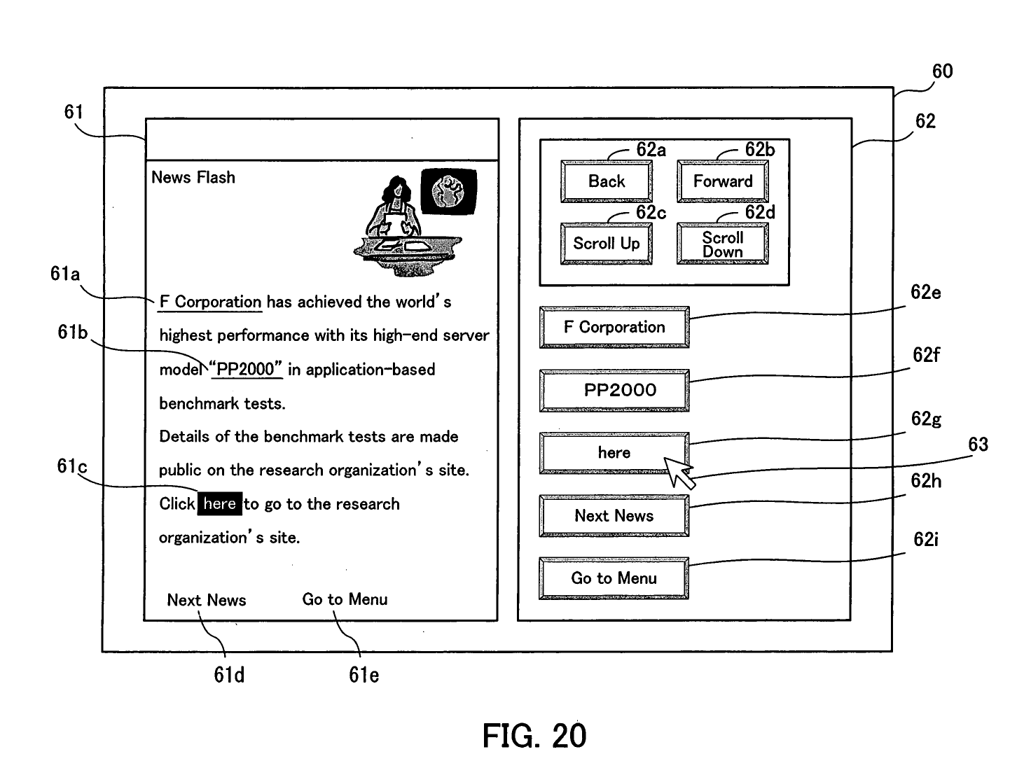

FIG. 20 shows an exemplary screen displayed when the document is browsed according to the third embodiment. A document screen 61 and a menu screen 62 are displayed on the screen 60 of the monitor 11. The document screen 61 shows the content of the document including a plurality of link information items 61a to 61e. The menu screen 62 shows a plurality of buttons 62a to 62i. Of these, the four buttons 62a to 62d are displayed irrespective of the link information in the document. The functions of the buttons 62a to 62d are identical with those of the respective buttons 42a to 42d of the first embodiment explained above with reference to FIG. 10.

The buttons 62e to 62i are associated with the link information items 61a to 61e. Specifically, the button 62e corresponds to the link information item 61a, the button 62f to the link information item 61b, the button 62g to the link information item 61c, the button 62h to the link information item 61d, and the button 62i to the link information item 61e.

If one of the buttons 62e to 62i corresponding to the link information items 61a to 61e is pointed with a mouse pointer 63, the corresponding link information item blinks. In the example of FIG. 20, the mouse pointer 63 is placed over the button 62g with the description “here”. Namely, the button 62g is specified. Accordingly, the description content “here” of the link information item 61c corresponding to the button 62g blinks on the document screen 61. For example, reverse blinking video is used as such blinking. In reverse blinking, the background is blinked, and the character string is reversed as the background is blinked. Specifically, in the case where before the blinking, the character string is shown in black on the white background, after the blinking the character string turns to black when the background is white, and turns to white when the background is black.

In this manner, the link information item corresponding to the button pointed with the mouse pointer 63 is highlighted, whereby the user can easily find the link information item corresponding to the button on the document screen 61. Accordingly, even in the case where it is impossible to estimate the content of a linked document corresponding to the button from the character string shown on the button, the user can easily find the corresponding link information item on the document screen 61 and conjecture the content of the linked document from the context of the text including the link information item. For example, even if the specified button is the button 62g showing the demonstrative “here”, the user realizes what kind of document the button is linked with, by referring to the character string “Click here to go to the research organization's site” including the corresponding link information item.

The link information may be blinked only when the description content does not clearly describe the content of a linked document, like a demonstrative.

### Fourth Embodiment

In the fourth embodiment, buttons shown in the menu screen are grouped by linked website. The elements constituting a browser of the fourth embodiment are almost identical with those of the browser 110 of the first embodiment shown in FIG. 4; therefore, the fourth embodiment will be described with reference to the elements shown in FIG. 4. In the fourth embodiment, the demonstrative list 114 shown in FIG. 4 is unnecessary. The functions of the other elements, except for the menu screen creation process executed by the menu creation section 115, are identical with those of the respective elements of the first embodiment. In the following, the menu screen creation process according to the fourth embodiment will be described.

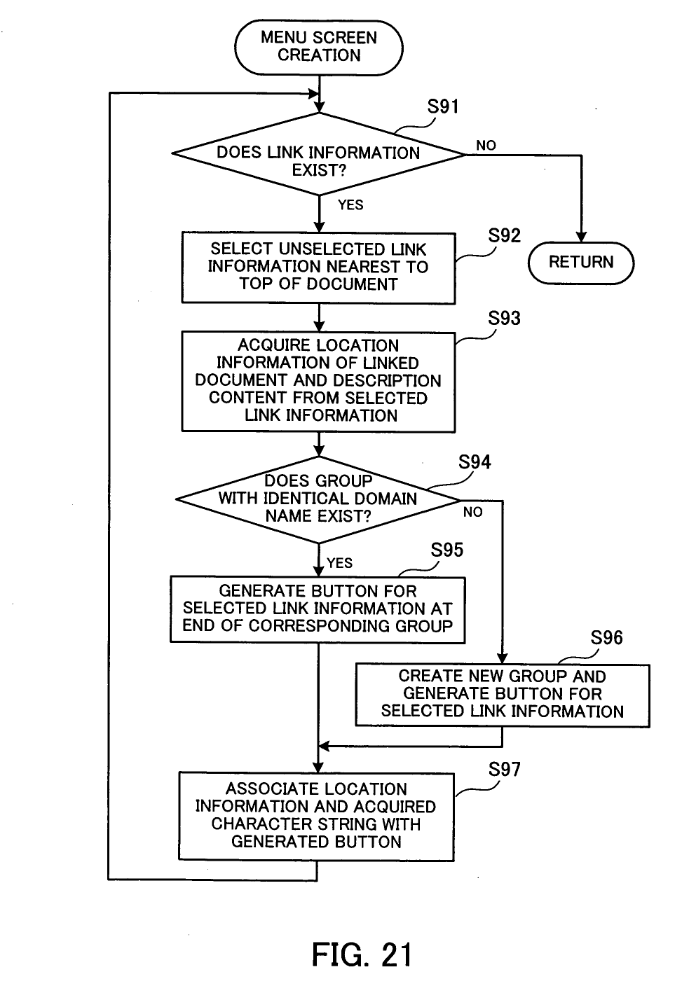

FIG. 21 is a flowchart illustrating the menu screen creation process according to the fourth embodiment. This process is executed by the menu creation section 115 when the document and the analysis results thereof are received from the link information analysis section 113. The process shown in FIG. 21 will be now explained in order of step number.

[Step S91] The menu creation section 115 determines whether or not there exists a link information item (unselected link information item) which is not yet processed in Step S92 and the succeeding steps, among the link information items extracted by the link information analysis section 113. If there is an unprocessed link information item, the process proceeds to Step S92; if all link information items have been processed, the process proceeds to Step S15 in FIG. 6.

[Step S92] The menu creation section 115 selects one unselected link information item which is nearest to the top of the document. Thus, the link information items are selected one by one in order from the top of the document.

[Step S93] The menu creation section 115 acquires, from the selected link information item, location information of a linked document and description content of the corresponding link.

[Step S94] The menu creation section 115 determines based on the domain name included in the location information whether or not a group with the same domain name already exists. If a group with the same domain name exists, the process proceeds to Step S95; if no such group exists, the process proceeds to Step S96.

[Step S95] The menu creation section 115 generates a button for the selected link information item at the end of the menu being created. When the created menu is displayed on the screen, a button generated earlier is located nearer to the top of the screen and a button generated later is located nearer to the bottom of the screen.

[Step S96] The menu creation section 115 creates a new group and generates a button for the selected link information item.

[Step S97] The menu creation section 115 associates the location information and the acquired character string with the generated button. The associated location information indicates the location of the document which is to be acquired when the button is selected. The character string has the description content acquired in Step S93. The process then proceeds to Step S91.

In this manner, a menu screen showing buttons grouped by domain name is created.

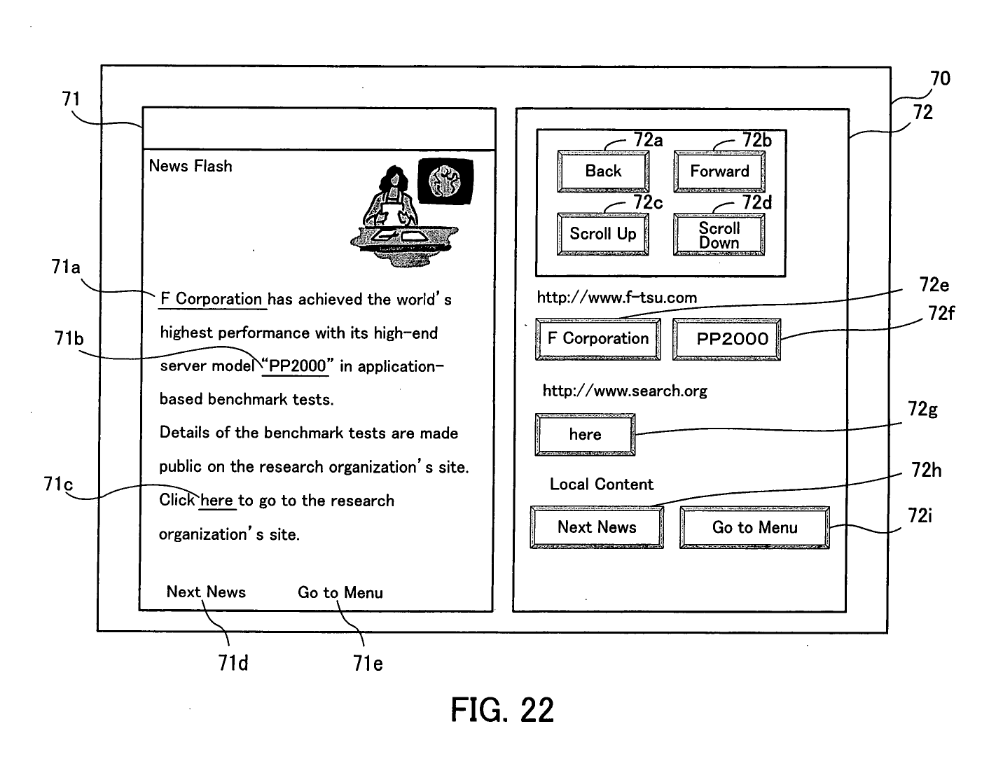

FIG. 22 shows an exemplary screen displayed when the document is browsed according to the fourth embodiment. A document screen 71 and a menu screen 72 are displayed on the screen 70 of the monitor 11. The document screen 71 shows the content of the document including a plurality of link information items 71a to 71e. The menu screen 72 shows a plurality of buttons 72a to 72i. Of these, the four buttons 72a to 72d are displayed irrespective of the link information in the document. The functions of the buttons 72a to 72d are identical with those of the respective buttons 42a to 42d of the first embodiment explained above with reference to FIG. 10.

The buttons 72e to 72i are associated with the link information items 71a to 71e. Specifically, the button 72e corresponds to the link information item 71a, the button 72f to the link information item 71b, the button 72g to the link information item 71c, the button 72h to the link information item 71d, and the button 72i to the link information item 71e.

The buttons 72e to 72i are divided into groups according to the domain names indicated by the location information of the respective link information items. The domain name is also shown along with the corresponding group of buttons. In the example of FIG. 22, the buttons 72e and 72f are shown side by side as the group with the domain name “http://www.f-tsu.com”, and the button 72g is shown as the group with the domain name “http://www.search.org”. Also, the buttons 72h and 72i are shown side by side as the group (local content) with the domain name identical with that of the currently displayed document.

In this manner, the buttons are grouped together, and accordingly, even if the link information items 71a to 7le are randomly placed in the document screen 71, the user can easily ascertain what websites the respective buttons are linked with, by referring to the menu screen 72.

### Fifth Embodiment

In the fifth embodiment, the update dates/times of linked documents are read in advance and buttons are shown in the menu screen in order of the update dates/times of the linked documents.

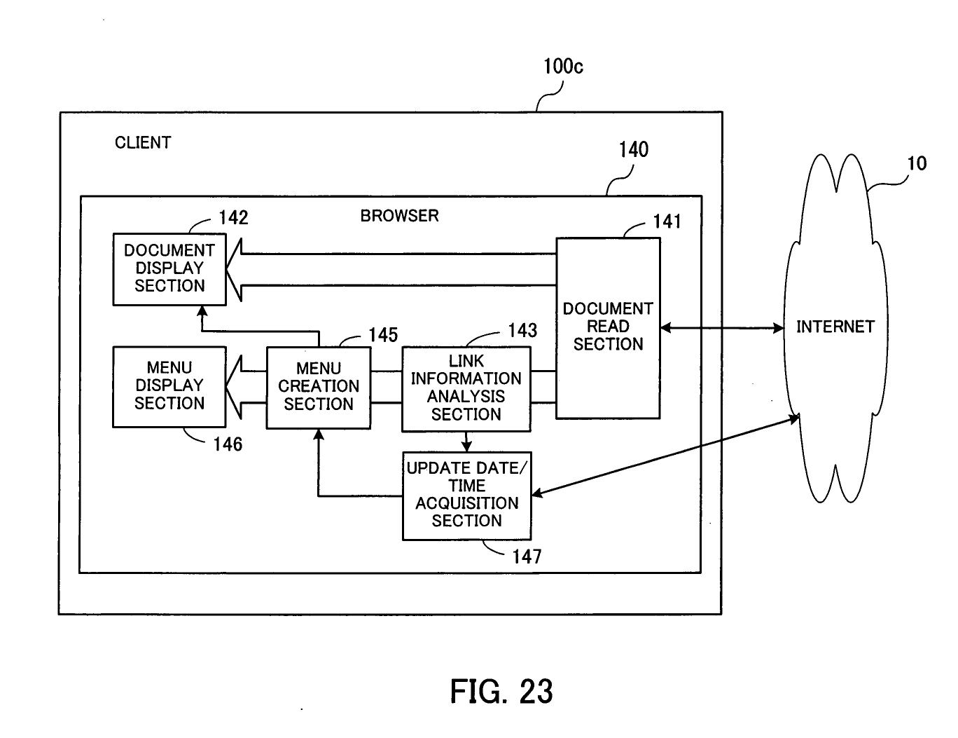

FIG. 23 is a block diagram illustrating functions of a browser according to the fifth embodiment. The browser 140 configured as shown in FIG. 23 is installed on a client 100c of the fifth embodiment. The browser 140 has a document read section 141, a document display section 142, a link information analysis section 143, a menu creation section 145, a menu display section 146, and an update date/time acquisition section 147. The document read section 141, the document display section 142 and the menu display section 146 have the same functions as those with the same names of the first embodiment shown in FIG. 4.

The link information analysis section 143 has the function described below, in addition to the function of the link information analysis section 113 of the first embodiment shown in FIG. 4. Specifically, after analyzing the document to extract link information therefrom, the link information analysis section 143 transfers location information in the extracted link information to the update date/time acquisition section 147.

On receiving the location information of the link information from the link information analysis section 143, the update date/time acquisition section 147 acquires, through the Internet 10, the update date/time of a document corresponding to the location information. Specifically, the update date/time acquisition section 147 transmits, via the Internet 10, an update date/time acquisition request specifying the document indicated by the location information, and receives the update date/time from a web server holding the document. Then, the update date/time acquisition section 147 transfers the received update date/time, together with the location information, to the menu creation section 145.

The menu creation section 145 has the function described below, in addition to the function of the menu creation section 115 of the first embodiment shown in FIG. 4. Specifically, the menu creation section 145 receives the document and the analysis results thereof from the link information analysis section 143, and also receives, from the update date/time acquisition section 147, the update date/time corresponding to the link information included in the analysis results. When creating the menu, the menu creation section 145 arranges buttons such that the button corresponding to the link information with the latest update date/time is located at the top of the menu.

A menu screen showing buttons arranged according to update dates/times is displayed by the browser 140 configured as described above. A general procedure of the process performed by the browser 140 is identical with that of the first embodiment shown in FIG. 6.

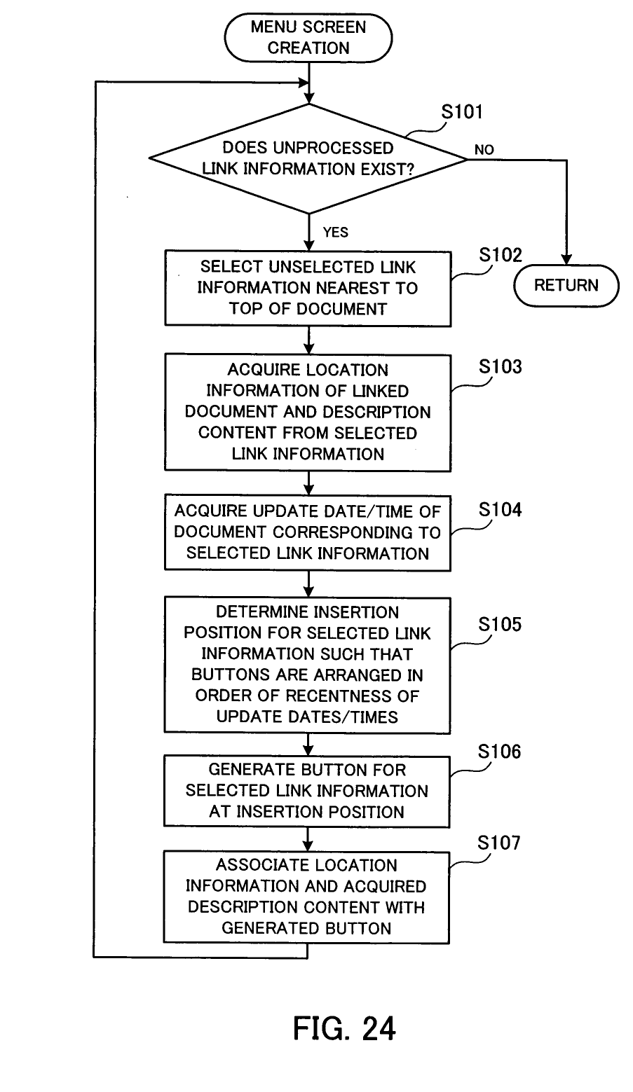

FIG. 24 is a flowchart illustrating the menu screen creation process according to the fifth embodiment. This process is executed by the menu creation section 145 when the document and the analysis results thereof are received from the link information analysis section 143. In the following, the process shown in FIG. 24 will be explained in order of step number.

[Step S101] The menu creation section 145 determines whether or not there exists a link information item (unselected link information item) which is not yet processed in Step S102 and the succeeding steps, among the link information items extracted by the link information analysis section 143. If there is an unprocessed link information item, the process proceeds to Step S102; if all link information items have been processed, the process proceeds to Step S15 in FIG. 6.

[Step S102] The menu creation section 145 selects one unselected link information item which is nearest to the top of the document. Thus, the link information items are selected one by one in order from the top of the document.

[Step S103] The menu creation section 145 acquires, from the selected link information item, location information of a linked document and description content of the corresponding link.

[Step S104] The menu creation section 145 acquires, from the update date/time acquisition section 147, the update date/time of the linked document corresponding to the selected link information item.

[Step S105] The menu creation section 145 determines the insertion position of a button for the selected link information item such that the buttons are arranged in order of recentness of the update dates/times from the top of the menu screen.

[Step S106] The menu creation section 145 generates the button for the selected link information item at the insertion position determined in Step S105.

[Step S107] The menu creation section 145 associates the location information and the acquired description content with the generated button. The associated location information indicates the location of the document which is to be acquired when the button is selected. The process then proceeds to Step S101.

The menu created in this manner shows buttons such that a button corresponding to the document with the latest update date/time appears first (at the top of the menu screen), whereby the user can browse the latest document with ease.

### Sixth Embodiment

According to the sixth embodiment, buttons in the menu screen show not only immediately linked documents but also sub-linked documents. In the sixth embodiment, the hierarchy of linked documents is shown in tree structure on the menu screen.

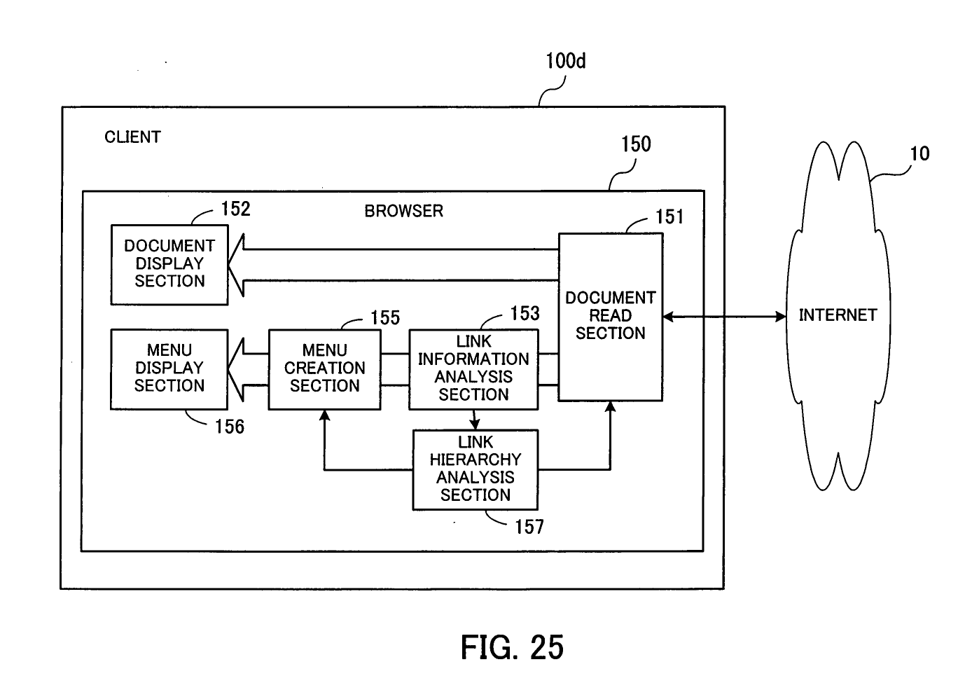

FIG. 25 is a block diagram illustrating the configuration of a browser according to the sixth embodiment. The browser 150 configured as shown in FIG. 25 is installed on a client 100d of the sixth embodiment. The browser 150 has a document read section 151, a document display section 152, a link information analysis section 153, a menu creation section 155, a menu display section 156, and a link hierarchy analysis section 157. The document display section 152 and the menu display section 156 have the same functions as those with the same names of the first embodiment shown in FIG. 4.

The document read section 151 has the function described below, in addition to the function of the document read section 111 of the first embodiment shown in FIG. 4. Specifically, the document read section 151 receives, from the link hierarchy analysis section 157, a request (linked document acquisition request) to acquire a linked document to which the acquired document is linked, and acquires the document corresponding to the location information specified by the acquisition request. Then, the document read section 151 transfers the document acquired in compliance with the linked document acquisition request, to the link information analysis section 153 as a sub-linked document.

The link information analysis section 153 has the function described below, in addition to the function of the link information analysis section 113 of the first embodiment shown in FIG. 4. Specifically, the link information analysis section 153 receives the document from the document read section 151 and transfers the results of analysis of the document to the link hierarchy analysis section 157. The document acquired in response to the linked document acquisition request is discarded by the link information analysis section 153 after the analysis (the document is not transferred to the menu creation section 155).

The link hierarchy analysis section 157 outputs an instruction to pre-read a document to which the acquired document is linked, and also identifies the hierarchical structure (parent-child relationship) of the link information of the document from which the link is anchored and the link information of the document to which the link is anchored. Specifically, on receiving the analysis results of the acquired document from the link information analysis section 153, the link hierarchy analysis section 157 determines, by tracing the link information of the document, how deep in hierarchical level (how many times) the link information has been traced forward from the document specified by the user's input operation. If the number of hierarchy levels reached is smaller than a preset number of pre-read levels, the link hierarchy analysis section 157 outputs a linked document acquisition request to the document read section 151 to request same to acquire the document specified by the location information included in the analysis results.

Also, when the analysis results of the document acquired in response to the linked document acquisition request are received from the link information analysis section 153, the link hierarchy analysis section 157 notifies the menu creation section 155 of the parent-child relationship between the link information (parent link information) from which the linked document acquisition request is derived and the link information (child link information) acquired from the analysis results.

The menu creation section 155 has the function described below, in addition to the function of the menu creation section 115 of the first embodiment shown in FIG. 4. Specifically, the menu creation section 155 arranges, using a tree structure, buttons corresponding to respective link information items indicated by the analysis results of multiple documents received from the link information analysis section 153, in accordance with the parent-child relationships received from the link hierarchy analysis section 157. For example, a parent and a child thereof are arranged left and right, respectively, and the parent-child relationship is indicated by a line connecting the two. The menu creation section 155 then transfers the created menu, in which the buttons corresponding to the acquired link information items are arranged as aforesaid, to the menu display section 156.

In the first embodiment, the link information items in the document displayed by the document display section 112 and the buttons shown in the menu are associated with each other by using identical numbers, but this process is omitted in the sixth embodiment. Accordingly, the menu creation section 155 does not carry out the modification process such as editing of the document transferred to the document display section 152.

The client 100d incorporating the browser 150 configured as above performs the process described below.

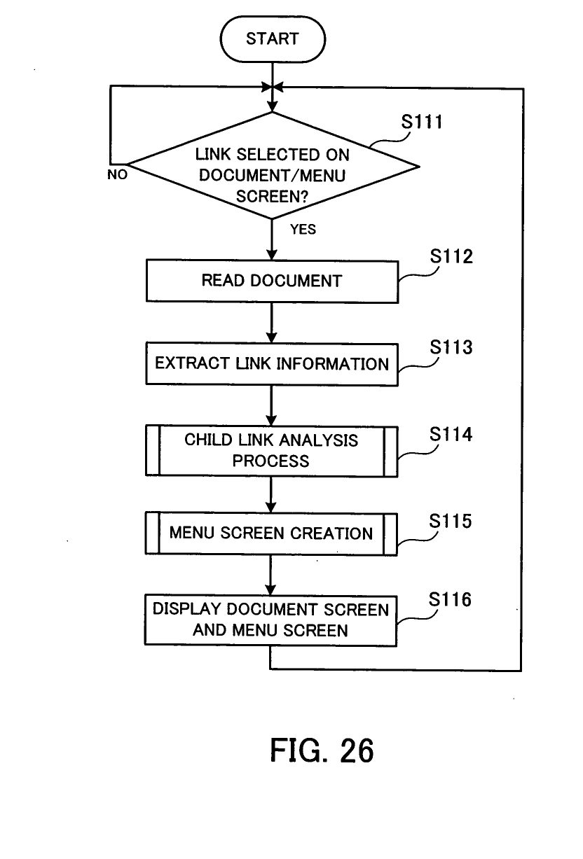

FIG. 26 is a flowchart illustrating the document display process according to the sixth embodiment. In the following, the process shown in FIG. 26 will be explained in order of step number.

[Step S111] The document read section 151 detects an input operation of the user by means of the mouse 13 or the like, and determines whether or not a link has been selected on the document/menu screen. If a link has been selected, the process proceeds to Step S112; if not, Step S111 is repeated.

[Step S112] The document read section 151 identifies the location of the linked document set with respect to the selected link and reads in the document from that location. Then, the document read section 151 transfers the read document to the document display section 152 and the link information analysis section 153.

[Step S113] The link information analysis section 153 analyzes the document and extracts link information therefrom. At this time, the link information analysis section 153 identifies location information of each linked document and description content of the corresponding link, set in the extracted link information. The link information analysis section 153 then transfers the document and the analysis results thereof to the menu creation section 155. Also, the link information analysis section 153 transfers the document analysis results to the link hierarchy analysis section 157.

[Step S114] The link hierarchy analysis section 157, the document read section 151 and the link information analysis section 153 cooperatively operate to perform a child link analysis process. This process will be described in detail later.

[Step S115] The menu creation section 155 performs a menu screen creation process, described in detail later.

[Step S116] The document display section 152 displays the document on the monitor 11. Simultaneously, the menu display section 156 displays the menu screen created by the menu creation section 155 on the monitor 11. The process then proceeds to Step S111, in which the document read section 151 waits for subsequent selection of a link.

Details of the child link analysis process will be now described.

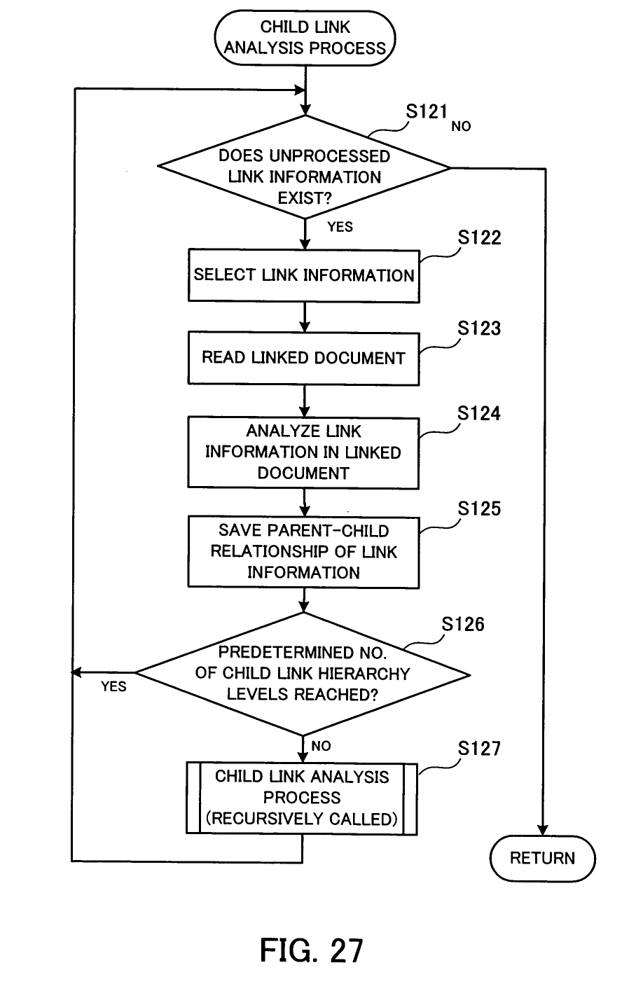

FIG. 27 is a flowchart illustrating the child link analysis process. When the child link analysis process is called in Step S114 in FIG. 26, the analysis results obtained in Step S113 (set of link information items contained in the document acquired in Step S112) are used as input data. Also, the child link analysis process is recursively called in Step S127 in FIG. 27. When the process is called in Step S127, the analysis results obtained in Step S124 (set of link information items contained in the document acquired in Step S123) are used as input data. In the following, the process shown in FIG. 27 will be explained in order of step number.

[Step S121] The link hierarchy analysis section 157 determines whether or not there exists an unprocessed link information item which is not yet processed in Step S122 and the succeeding steps, among the input data. If there is an unprocessed link information item, the process proceeds to Step S122.

If there is no unprocessed link information item, the child link analysis process is ended and the process from which the child link analysis process has been called is continued. Specifically, if the child link analysis process has been called in Step S114 in FIG. 26, the process of FIG. 26 is restarted from the subsequent Step S115. If the process has been called in Step S127 in FIG. 27, the child link analysis process from which the process has been called is continued from Step S121.

[Step S122] The link hierarchy analysis section 157 selects one unprocessed link information item from among the set of input link information items. Then, the link hierarchy analysis section 157 outputs a linked document acquisition request specifying the location information included in the selected link information item, to the document read section 151.

[Step S123] On receiving the linked document acquisition request, the document read section 151 acquires, via the Internet 10, the document corresponding to the location information specified in the acquisition request. The document read section 151 then transfers the read document to the link information analysis section 153.

[Step S124] The link information analysis section 153 analyzes the document transferred from the document read section 151 and extracts link information items therefrom. Then, the link information analysis section 153 transfers the extracted link information items to the link hierarchy analysis section 157.

[Step S125] The link hierarchy analysis section 157 saves the parent-child relationship between the link information item from which the link is anchored and the link information items in the linked document. Specifically, the link hierarchy analysis section 157 saves the parent-child relationship by treating the link information item selected in Step S122, as a parent, and the link information items included in the analysis results obtained in Step S124, as children.

[Step S126] The link hierarchy analysis section 157 determines whether or not a predetermined number of child link hierarchy levels has been reached. If the predetermined number of child link hierarchy levels has been reached, the process proceeds to Step S121; if not, the process proceeds to Step S127.

[Step S127] The link hierarchy analysis section 157 recursively calls the child link analysis process which uses the analysis results obtained in Step S124 as the input data. When the recursively called child link analysis process is ended, the process proceeds to Step S121.

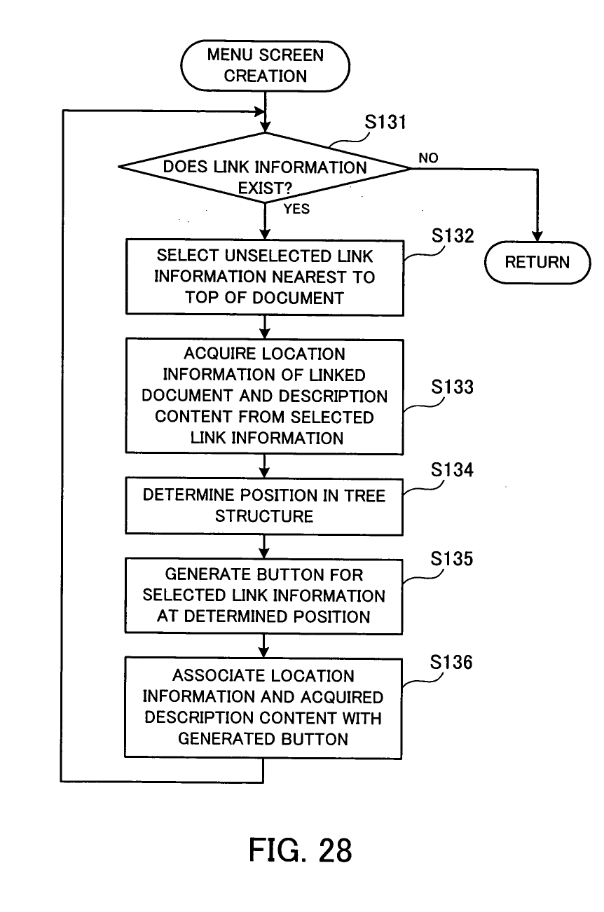

FIG. 28 is a flowchart illustrating the menu screen creation process according to the sixth embodiment. In the following, the process shown in FIG. 28 will be explained in order of step number.

[Step S131] The menu creation section 155 determines whether or not there exists a link information item (unselected link information item) which is not yet processed in Step S132 and the succeeding steps, among the link information items extracted by the link information analysis section 153. If there is an unprocessed link information item, the process proceeds to Step S132; if all link information items have been processed, the process proceeds to Step S116 in FIG. 26.

[Step S132] The menu creation section 155 selects one unselected link information item which is nearest to the top of the document. Thus, the link information items are selected one by one in order from the top of the document.

[Step S133] The menu creation section 155 acquires, from the selected link information item, location information of a linked document and description content of the corresponding link.

[Step S134] The menu creation section 155 looks up information indicating the parent-child relationship saved by the link hierarchy analysis section 157, to determine the position in tree structure of the link information item selected in Step S132. Specifically, the menu creation section 155 identifies the parent link information item of the link information item selected in Step S132 and determines the position for the selected link information item such that the selected link information item is located as a child of the parent link information item in the tree structure.

[Step S135] The menu creation section 155 generates a button for the selected link information item at the determined position. At this time, a line indicating the parent-child relationship is drawn from the button corresponding to the parent link information item to the generated button.

[Step S136] The menu creation section 155 associates the location information and the acquired description content with the generated button. The associated location information indicates the location of the document which is to be acquired when the button is selected. The process then proceeds to Step S131.

The menu created in this manner is displayed on the screen, whereby the paths of link information items that can be traced from the document displayed on the screen are shown in tree structure on the menu screen.

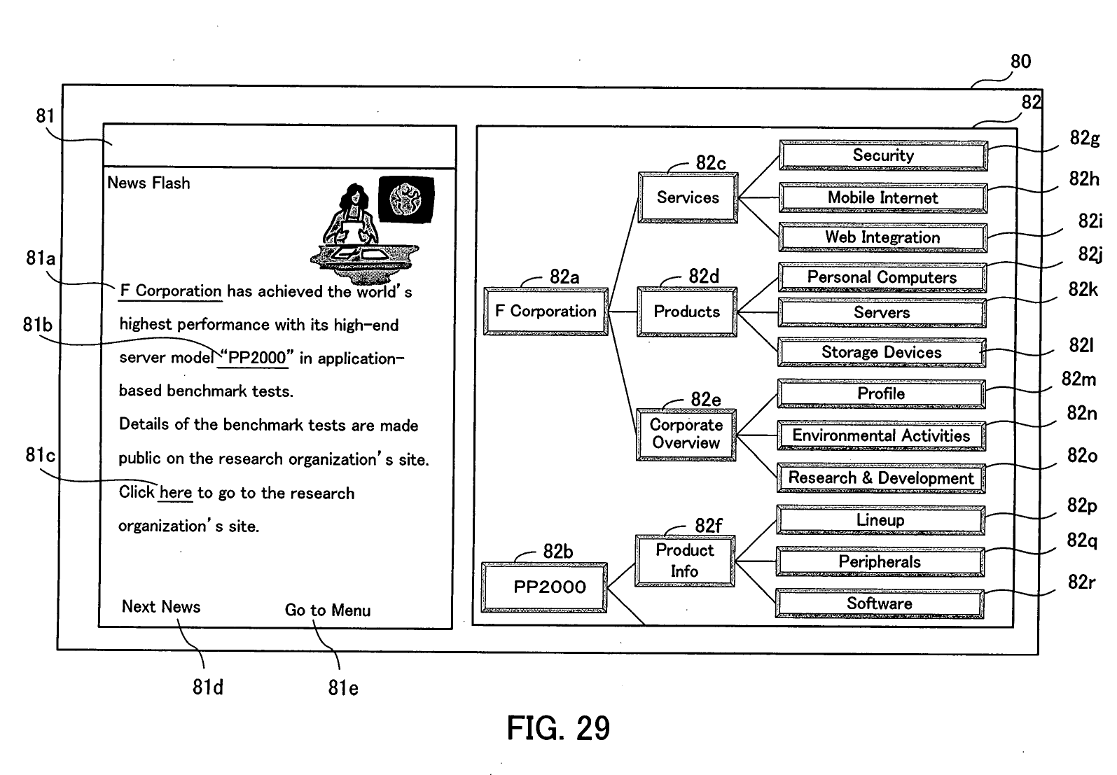

FIG. 29 shows an exemplary screen displayed when the document is browsed according to the sixth embodiment. A document screen 81 and a menu screen 82 are displayed on the screen 80 of the monitor 11. The document screen 81 shows the content of the document including a plurality of link information items 81a to 81e. The menu screen 82 shows a plurality of buttons 82a to 82r. FIG. 29 shows only part of buttons to be displayed on the menu screen 82 and the other buttons can displayed on the screen by scrolling the menu screen 82.

The buttons 82a and 82b are buttons (first hierarchy level buttons) corresponding to the link information items included in the document (document linked to first hierarchy level documents) displayed on the document screen 81. The button 82a corresponds to the link information item 81a with the description “F Corporation”, and the button 82b corresponds to the link information item 81b with the description “PP2000”.

The buttons 82c to 82f are buttons (second hierarchy level buttons) corresponding to link information items included in documents (buttons linked to second hierarchy level documents) associated with the first hierarchy level buttons 82a and 82b. The buttons 82c to 82e are generated from the link information items in the document corresponding to the button 82a, and the button 82f is generated from a link information item in the document corresponding to the button 82b.

The buttons 82g to 82r are buttons (third hierarchy level buttons) corresponding to link information items included in the documents (buttons linked to third hierarchy level documents) associated with the second hierarchy level buttons 82c to 82f. The buttons 82g to 82i are generated from the link information items in the document corresponding to the button 82c, and the buttons 82j to 821 are generated from the link information items in the document corresponding to the button 82d. The buttons 82m to 82o are generated from the link information items in the document corresponding to the button 82e, and the buttons 82p to 82r are generated from the link information items in the document corresponding to the button 82f.

In the example of FIG. 29, the buttons of up to the third hierarchy level are displayed. The linkage may be traced deeper in the hierarchy to be displayed in tree structure. The hierarchy level up to which the linkage is to be traced and displayed can be optionally specified by the user's input operation.

As described above, buttons corresponding to the documents up to which the linkage is traceable from the displayed document are shown by means of the linkage-based tree structure, whereby the user can switch the screen directly to a target document screen by skipping intervening documents, without following links. This significantly reduces the time and labor required to have a target document displayed.

Let it be assumed that the user wishes to refer to information about F Corporation's personal computers, for example. With conventional browsers, first, the link information item “F Corporation” is selected on the document screen to display the document showing F Corporation's main page. Subsequently, on the screen showing F Corporation's main page, the link information item “Products” is selected to display the document introducing products. Further, on the screen introducing the products, the link information item “Personal Computers” is selected, whereupon the contents of the document introducing F Corporation's personal computers are shown on the screen.

According to the sixth embodiment, on the other hand, by selecting the button 82j with the description “Personal Computers” on the menu screen 82, it is possible to cause the browser to display the document introducing F Corporation's personal computers. Thus, the operational efficiency at the time of browsing hypertext documents improves.

### Seventh Embodiment

In the seventh embodiment, when a button is specified as a possible selection by the user, buttons corresponding to the link information items included in the document corresponding to the specified button are shown in tree structure.

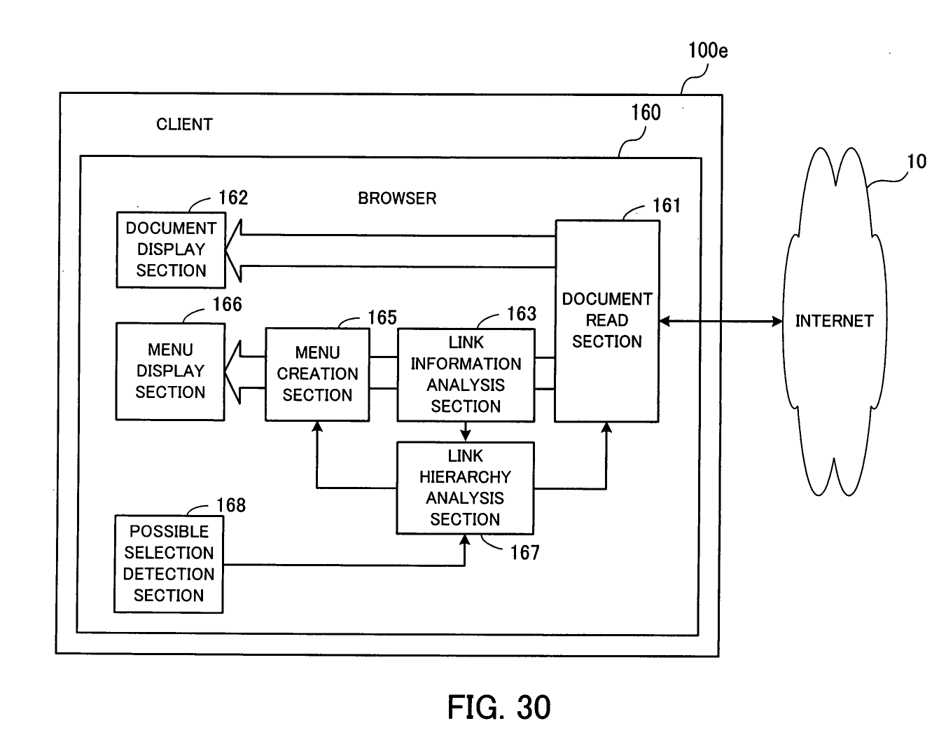

FIG. 30 is a block diagram showing the configuration of a browser according to the seventh embodiment. The browser 160 configured as shown in FIG. 30 is installed on a client 100e of the seventh embodiment. The browser 160 has a document read section 161, a document display section 162, a link information analysis section 163, a menu creation section 165, a menu display section 166, a link hierarchy analysis section 167, and a possible selection detection section 168. The document read section 161, the document display section 162 and the link information analysis section 163 have the same functions as those with the same names of the sixth embodiment shown in FIG. 25.

The possible selection detection section 168 monitors the on-screen position of the mouse pointer, to detect the movement of the mouse pointer to a position over any of the buttons in the menu screen (only the buttons corresponding to the respective link information items in the document). The possible selection detection section 168 then extracts the link information items associated with the button pointed with the mouse pointer and transfers the extracted link information items to the link hierarchy analysis section 167.

The link hierarchy analysis section 167 outputs an instruction to pre-read a document corresponding to the button specified by the user as a possible selection, and also identifies the hierarchical structure (parent-child relationship) of the link information of the document from which the link is anchored and the link information of the document to which the link is anchored. Specifically, on receiving the link information of the button specified as a possible selection from the possible selection detection section 168, the link hierarchy analysis section 167 outputs a linked document acquisition request specifying the location information included in the link information, to the document read section 161.

Also, when the analysis results of the document acquired in response to the linked document acquisition request are received from the link information analysis section 163, the link hierarchy analysis section 167 notifies the menu creation section 165 of the parent-child relationship between the link information (parent link information) from which the linked document acquisition request is derived and the link information (child link information) acquired from the analysis results.

The menu creation section 165 has the function described below, in addition to the function of the menu creation section 155 of the sixth embodiment shown in FIG. 25. Specifically, each time the document analysis results are received from the link information analysis section 163, the menu creation section 165 acquires, from the link hierarchy analysis section 167, the parent-child relationship between the link information (child link information) included in the analysis results and the link information (parent link information) corresponding to the button already included in the menu, and updates the menu. As such menu updating process, the menu creation section 165 adds buttons corresponding to the child link information to the right of the button corresponding to the parent link information.

The process executed in the seventh embodiment from the reading of a document specified by the user's input operation to the display of the document screen and the menu screen by the document display section 162 and the menu display section 166, respectively, is almost identical with that executed in the first embodiment. For simplicity of explanation of the seventh embodiment, however, it is assumed that a demonstrative as description content is displayed as it stands and that numbers showing the correspondence between link information items and buttons are not displayed.

In the seventh embodiment, when a button in the menu screen is specified as a possible selection while the document and menu screens are displayed, the browser 160 performs a menu screen updating process.

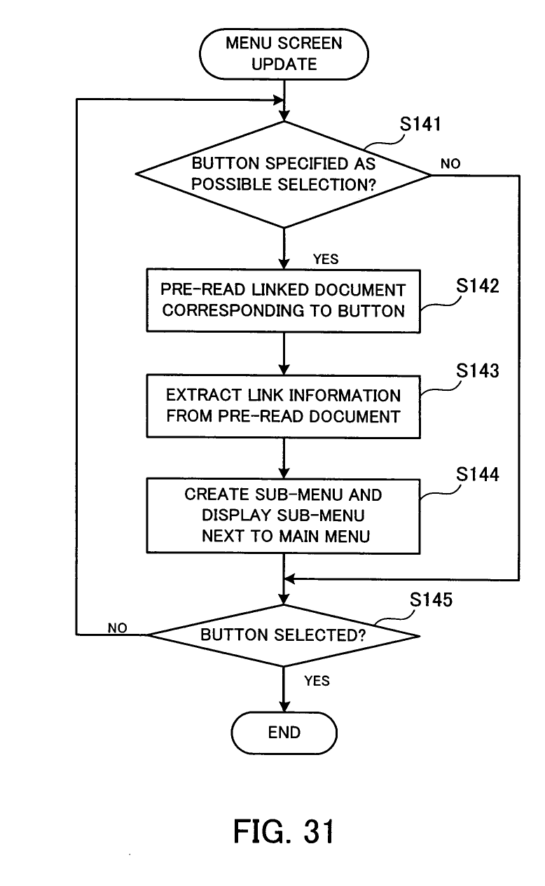

FIG. 31 is a flowchart illustrating the menu screen updating process. In the following, the process shown in FIG. 31 will be explained in order of step number.

[Step S141] The possible selection detection section 168 determines whether or not a button is specified as a possible selection by the user. Specifically, if the mouse pointer of the mouse manipulated by the user is moved to a position over any of the buttons in the menu screen, the possible selection detection section 168 judges that the button pointed with the mouse pointer has been specified as a possible selection. If a button is specified as a possible selection, the link information item corresponding to the specified button is transferred from the possible selection detection section 168 to the link hierarchy analysis section 167, and the process proceeds to Step S142. If no button is specified as a possible selection, the process proceeds to Step S145.

[Step S142] Based on the link information item received from the possible selection detection section 168, the link hierarchy analysis section 167 outputs a request (linked document acquisition request) to the document read section 161 to request same to acquire the document corresponding to the button specified by the user. Then, the document corresponding to the specified button is read in through the Internet 10 by the document read section 161 and transferred to the link information analysis section 163. Namely, the linked document is pre-read.

[Step S143] The link information analysis section 163 analyzes the pre-read document and extracts link information items therefrom. Then, the link information analysis section 163 transfers the extracted link information items to the menu creation section 165 and the link hierarchy analysis section 167.

[Step S144] The link hierarchy analysis section 167 associates the parent link information received from the possible selection detection section 168 with the child link information received from the link information analysis section 163, and notifies the menu creation section 165 of the parent-child relationship. Based on the information about the parent-child relationship received from the link hierarchy analysis section 167, the menu creation section 165 determines the position in tree structure of the link information items received from the link information analysis section 163. Then, the menu creation section 165 additionally generates, at the determined position, a sub-menu containing buttons corresponding to the link information items received from the link information analysis section 163, and transfers information about the generated sub-menu to the menu display section 166. Thereupon, the menu display section 166 additionally displays the sub-menu next to the main menu in the menu screen.

[Step S145] The document read section 161 determines whether or not a button in the menu screen has been selected. For example, if, with any button in the menu screen pointed with the mouse pointer, the button of the mouse 13 is depressed, it is judged that the button pointed with the mouse pointer has been selected. If a button is selected, the browser 160 terminates the menu screen updating process and starts the process for displaying the next document. Specifically, on selection of a button, a document corresponding to the selected button is read and displayed in the document screen, and also a menu screen corresponding to the document is displayed. The menu screen updating process for the newly displayed document is started thereafter. If no button is being selected, the process proceeds to Step S141 to continue the detection of the user's operation specifying a possible selection.

In this manner, each time a possible selection is specified, the corresponding document is pre-read and buttons corresponding to the link information items included in the document specified as the possible selection are shown in the menu screen.

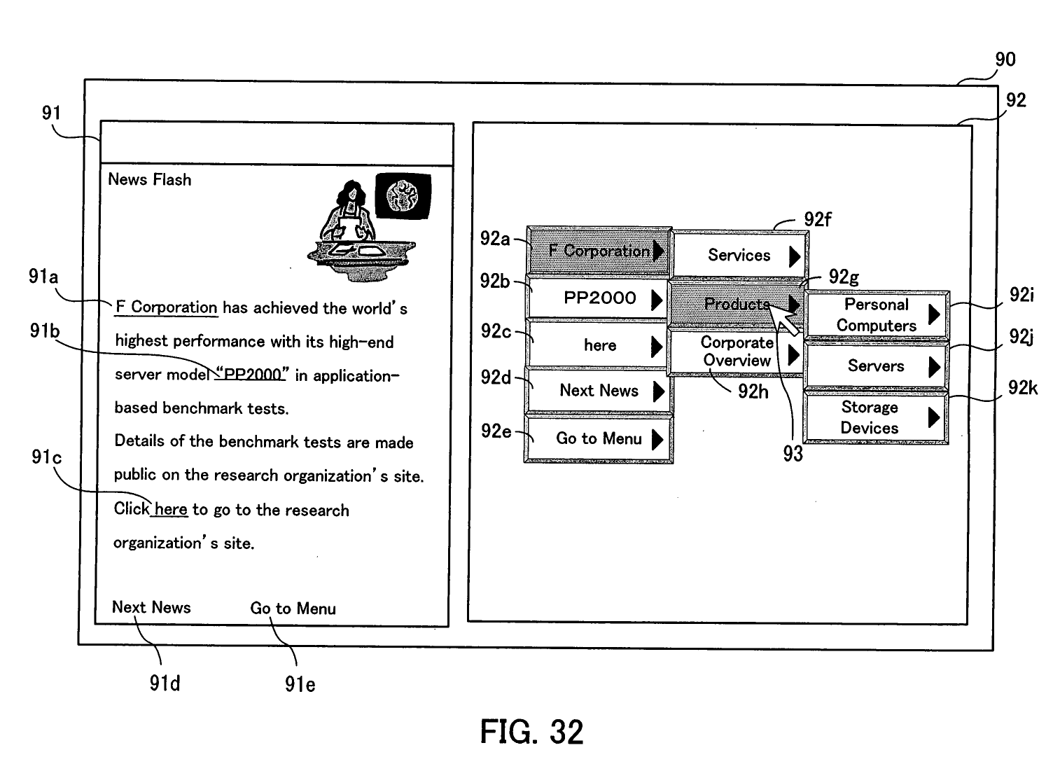

FIG. 32 shows an exemplary screen displayed when the document is browsed according to the seventh embodiment. A document screen 91 and a menu screen 92 are displayed on the screen 90 of the monitor 11. The document screen 91 shows the content of the document including a plurality of link information items 91a to 91e. The menu screen 92 shows a plurality of buttons 92a to 92k.

The buttons 92a to 92e correspond to the link information items 91a to 91e, respectively, displayed in the document screen 91. In the example of FIG. 32, the button 92a is specified as a possible selection. In consequence, the buttons 92f to 92h associated with the link information items included in the document corresponding to the button 92a are shown as a sub-menu to the right of the button 92a. Also, in the example of FIG. 32, the mouse pointer 93 is moved to a position over the button 92g to specify the button 92g as a possible selection. Accordingly, the buttons 92i to 92k associated with the link information items included in the document corresponding to the button 92g are shown as a sub-menu to the right of the button 92g.

In this manner, link information items linked from the document corresponding to the button specified as a possible selection are successively displayed, and accordingly, the user can follow links between documents and select a desired document without the need to update the document screen. Thus, the operational efficiency at the time of browsing hypertext improves.

Other Exemplary Applications

In the foregoing embodiments, the document screen and the menu screen are displayed on the monitor 11 of the client, but may alternatively be displayed on different display devices. For example, in the case of web television whereby web content can be browsed on a home television set connected to the Internet 10, the menu screen may be displayed on the remote control of the television set. In this case, the menu display section 116 (FIG. 4) of the first embodiment, for example, is incorporated into the remote control. The menu display section 116 communicates with the other elements by communication means (e.g., infrared communication) used for the communication between the remote control and the television set.

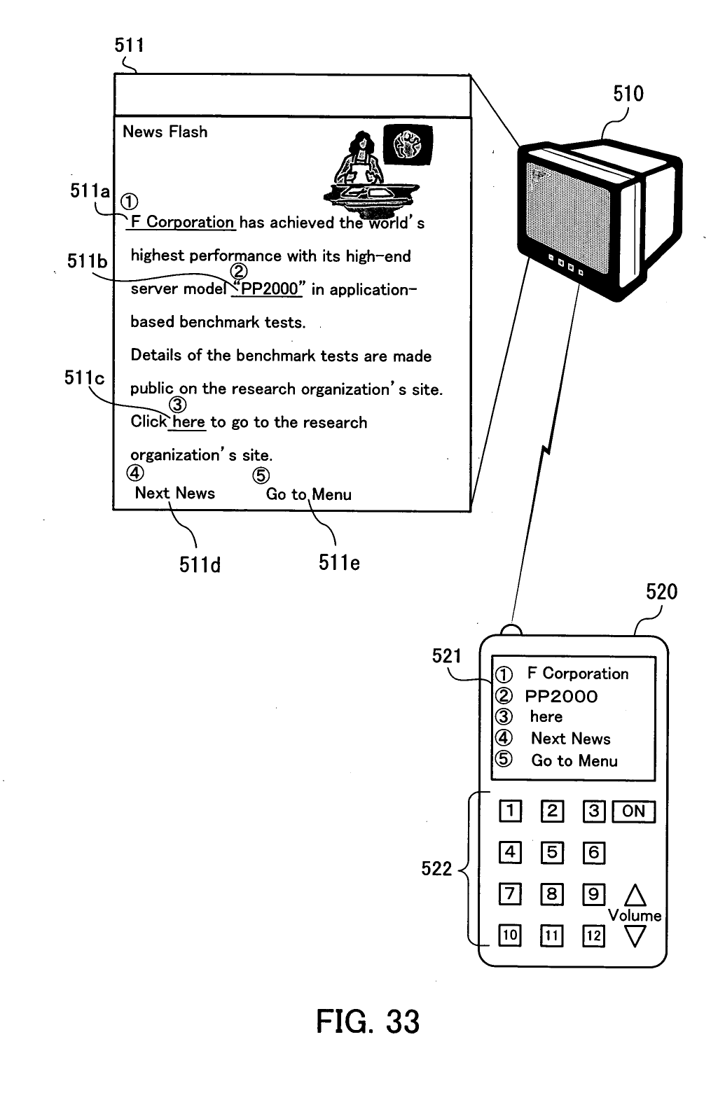

FIG. 33 illustrates an exemplary case where the document screen and the menu screen are displayed on different devices. In the example of FIG. 33, the document screen 511 is displayed on a television set 510, and the menu screen 521 is displayed on the display device (e.g., liquid-crystal display device) of a remote control 520 for the television set 510.

In the document screen 511, link information items 511a to 511e contained in the document are assigned respective numbers, as in the first embodiment. The menu screen 521 displayed on the remote control 520 shows the description contents of the link information items 511a to 51e in a manner associated with the numbers assigned to the respective items 511a to 511e.

The remote control 520 is provided with numerical keys 522. When one of the numerical keys 522 corresponding to any of the numbers assigned to the link information items 511a to 51e is depressed, information about the depressed key is communicated to the television set 510 by infrared radiation or the like. Thereupon, the television set 510 judges that the link information item corresponding to the depressed key has been selected, and therefore, acquires the document corresponding to the link information item.

Thus, the menu screen 521 is displayed on the remote control 520, and this permits the user to easily select a link information item at a place remote from the device displaying the document.

Also, two or more of the configurations described in the foregoing embodiments may be incorporated in the browser so that the method of displaying the menu screen etc. can be switched in response to the user's input operation. This makes it possible for the user to display the menu screen in the form he or she desires.

The processing functions of the individual browsers of the foregoing embodiments can be performed by a computer. In this case, a program is prepared in which are described processes for performing the functions of the browser. The program is executed by a computer, whereupon the aforementioned processing functions are accomplished by the computer. The program describing the required processes may be recorded on a computer-readable recording medium. The computer-readable recording medium includes a magnetic recording device, an optical disc, a magneto-optical recording medium, a semiconductor memory, etc. The magnetic recording device may be a hard disk drive (HDD), a flexible disk (FD), a magnetic tape or the like. As the optical disc, a DVD (Digital Versatile Disc), a DVD-RAM (Random Access Memory), a CD-ROM (Compact Disc Read Only Memory), a CD-R (Recordable)/RW (ReWritable) or the like may be used. The magneto-optical recording medium includes an MO (Magneto-Optical disc) etc.

To market the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer loads the program from its storage device and performs processes in accordance with the program. The computer may load the program directly from the portable recording medium to perform processes in accordance with the program. Also, as the program is transferred from the server computer, the computer may sequentially perform processes in accordance with the received program.

As described above, according to the present invention, not only a document but the display form including the description contents of link information is displayed, and accordingly, the user can visually ascertain with ease that the link information is contained in the document.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A document display program for displaying a document containing a link anchored to a different document,
wherein the document display program causes a computer to perform the process of:
extracting, when the document is input, link information including location information of a linked document and description content indicative of presence of a link, from the input document;
generating an object corresponding to the extracted link information; and
displaying the document together with the generated object in such a display form as to include the description content included in the corresponding link information.

2. The document display program according to claim 1, wherein, when the object is to be displayed, it is determined whether or not the description content clearly indicates content of the linked document, and if it is judged that the description content does not clearly indicate the content of the linked document, text surrounding the description content is included in the display form of the object.

3. The document display program according to claim 2, wherein the determination as to whether the description content clearly indicates the content of the linked document or not is made by determining whether or not the description content is included in a list of demonstratives registered beforehand.

4. The document display program according to claim 1, wherein the document display program further causes the computer to performs the process of:
grouping, when a plurality of link information items are extracted as the link information, those link information items of which the location information has a common predetermined part, and displaying objects corresponding to the extracted link information items such that the objects are arranged in groups.

5. The document display program according to claim 4, wherein the predetermined part of the location information is a part identifying a computer in which the linked document is stored.

6. The document display program according to claim 1, wherein the document display program further causes the computer to perform the process of:
pre-reading, when the document is input, relevant documents that can be reached by tracing linkage forward a predetermined number of times from the link information extracted from the input document;
extracting relevant document link information items from the pre-read relevant documents;
generating relevant objects corresponding to the extracted relevant document link information items; and
displaying the relevant objects in a manner associated with the object.

7. The document display program according to claim 6, wherein, when the relevant objects are displayed in a manner associated with the object, paths for tracing linkage from the object as starting point are shown in tree structure.

8. The document display program according to claim 1, wherein the document display program further causes the computer to perform the process of:
pre-reading, when the object is specified as a possible selection, the linked document in accordance with the location information included in the link information corresponding to the specified object;
extracting linked document link information from the pre-read linked document;
generating a linked document correspondence object corresponding to the extracted linked document link information; and
displaying the linked document correspondence object in a manner associated with the object.

9. The document display program according to claim 1, wherein the document display program further causes the computer to perform the process of:
displaying, when a plurality of link information items are extracted as the link information, objects corresponding to the respective link information items such that the objects are arranged in order of occurrence of the link information items in the document.

10. The document display program according to claim 1, wherein the document display program further causes the computer to perform the process of:
displaying, when a plurality of link information items are extracted as the link information, objects corresponding to the respective link information items such that the objects are arranged in descending order of reference counts by which other documents are referred to in accordance with the respective link information items.

11. The document display program according to claim 1, wherein the document display program further causes the computer to perform the process of:
acquiring, when a plurality of link information items are extracted as the link information, update dates/times of linked documents in accordance with location information included in the respective link information items; and
displaying objects corresponding to the respective link information items such that the objects are arranged in order of recentness of the update dates/times of the linked documents.

12. The document display program according to claim 1, wherein the document display program further causes the computer to perform the process of:
displaying common identification information near the link information in the document and near the object corresponding to the link information.

13. The document display program according to claim 1, wherein the document display program further causes the computer to perform the process of:
identifying, when the object is specified as a possible selection, description content of the link information corresponding to the specified object from within the displayed document; and
highlighting the identified description content.

14. The document display program according to claim 13, wherein the identified description content is blinked for highlighting.

15. The document display program according to claim 1, wherein the document display program further causes the computer to perform the process of:
acquiring, when the object is selected by an input operation, the linked document in accordance with the location information included in the link information corresponding to the selected object.

16. A document display method for displaying a document containing a link anchored to a different document, comprising the steps of:
extracting, when the document is input, link information including location information of a linked document and description content indicative of presence of a link, from the input document;
generating an object corresponding to the extracted link information; and
displaying the document together with the generated object in such a display form as to include the description content included in the corresponding link information.

17. A document display device for displaying a document containing a link anchored to a different document, comprising:
link information extraction means for extracting, when the document is input, link information including location information of a linked document and description content indicative of presence of a link, from the input document;
object generation means for generating an object corresponding to the link information extracted by the link information extraction means; and
display means for displaying the document together with the object generated by the object generation means in such a display form as to include the description content included in the corresponding link information.

18. A computer-readable recording medium recording a document display program for displaying a document containing a link anchored to a different document,
wherein the document display program causes the computer to perform the process of:
extracting, when the document is input, link information including location information of a linked document and description content indicative of presence of a link, from the input document;
generating an object corresponding to the extracted link information; and
displaying the document together with the generated object in such a display form as to include the description content included in the corresponding link information.
